(19) United States
(12) Patent Application Publication
(10) Pub. No.: US 2018/0113216 A1
(43) Pub. Date: Apr. 26, 2018

(54) Methods Circuits Devices Assemblies Systems and Functionally Associated Machine Executable Code for Active Optical Scanning of a Scene

(71) Applicant: INNOVIZ TECHNOLOGIES LTD., Kfar Saba (IL)

(72) Inventors: Hanoch Kremer, Herzelyia (IL); Amit Steinberg, Adanim (IL); Oren Buskila, Hod Hasharon (IL); Omer Keilaf, Kfar Saba (IL); Guy Zohar, Netanya (IL); Nir Osiroff, Givatayim (IL); Ronen Eshel, Givatayim (IL); Oded Yeruhami, Tel Aviv (IL); Pavel Berman, Ramat Gan (IL); David Elooz, Kfar Haroeh (IL); Yair Antman, Petach Tikva (IL); Julian Vlaiko, Kfar Saba (IL)

(21) Appl. No.: 15/393,749

(22) Filed: Dec. 29, 2016

Related U.S. Application Data
(60) Provisional application No. 62/412,294, filed on Oct. 25, 2016.
(60) Provisional application No. 62/414,740, filed on Oct. 30, 2016.

(51) Int. Cl. G01S 17/89; H04W 4/04; G01S 17/93; G01S 17/02; G01S 7/481

(52) U.S. Cl. CPC G01S 17/89; H04W 4/046; G01S 7/4817; G01S 17/023; G01S 17/936

(57) ABSTRACT

Disclosed is a scanning device including: a photonic emitter assembly (PTX) to emit at least one pulse of inspection photons in accordance with at least one adjustable pulse parameter, a photonic reception and detection assembly (PRX) to receive reflected photons reflected back from an object, the PRX including a detector to detect in accordance with at least one adjustable detection parameter the reflected photons and produce a detected scene signal, and a closed loop controller to: (a) control the PTX and PRX, (b) receive the detected scene signal from the detector and (c) update said at least one pulse parameter and at least one detection parameter at least partially based on a work plan derived at least partially from the detected scene signal.

### RELATED APPLICATIONS

The present application claims priority from U.S. Provisional Patent Application No. 62/412,294, entitled: “Method and system for LiDAR active and dynamic Field of View (FOV) optimization based on predicted background modeling”, filed on Oct. 25, 2016; and from U.S. Provisional Patent Application No. 62/414,740, entitled: “LiDAR dynamic laser power management”, filed on Oct. 30, 2016; both of which applications are hereby incorporated by reference into the present application in their entirety.

### FIELD OF THE INVENTION

The present invention relates generally to the field of scene scanning. More specifically, the present invention relates to methods, circuits devices assemblies systems and functionally associated machine executable code for active optical scanning of a scene.

### BACKGROUND

Lidar which may also be called “LADAR” is a surveying method that measures a distance to a target by illuminating that target with a laser light. Lidar is sometimes considered an acronym of “Light Detection And Ranging”, or a portmanteau of light and radar and is used with terrestrial, airborne, and mobile applications.

Autonomous Vehicle Systems are directed to vehicle level autonomous systems involving a LiDAR system. An autonomous vehicle system stands for any vehicle integrating partial or full autonomous capabilities.

Autonomous or semi-autonomous vehicles are vehicles (such as motorcycles, cars, buses, trucks and more) that at least partially control a vehicle without human input. The autonomous vehicles, sense their environment and navigate to a destination input by a user/driver.

Unmanned aerial vehicles, which may be referred to as drones are aircrafts without a human on board may also utilize Lidar systems. Optionally, the drones may be manned/controlled autonomously or by a remote human operator.

Autonomous vehicles and drones may use Lidar technology in their systems to aid in detecting and scanning a scene/the area in which the vehicle and/or drones are operating in.

LiDAR systems, drones and autonomous (or semi-autonomous) vehicles are currently expensive and non-reliable, unsuitable for a mass market where reliability and dependence are a concern—such as the automotive market.

Host Systems are directed to generic host-level and system-level configurations and operations involving a LiDAR system. A host system stands for any computing environment that interfaces with the LiDAR, be it a vehicle system or testing/qualification environment. Such computing environment includes any device, PC, server, cloud or a combination of one or more of these. This category also covers, as a further example, interfaces to external devices such as camera and car ego-motion data (acceleration, steering wheel deflection, reverse drive, etc.). It also covers the multitude of interfaces that a LiDAR may interface with the host system, such as a CAN bus.

### SUMMARY OF THE INVENTION

The present invention includes methods, circuits, assemblies, devices, systems and functionally associated machine executable code for active scene scanning. A scanning device may include: a photonic emitter assembly (PTX) to emit at least one pulse of inspection photons in accordance with at least one adjustable pulse parameter; a photonic reception and detection assembly (PRX) to receive reflected photons reflected back from an object, the PRX may include a detector to detect in accordance with at least one adjustable detection parameter the reflected photons and produce a detected scene signal, a photonic steering assembly (PSY) functionally associated with both the PTX and the PRX to direct the pulses of inspection photons in a direction of an inspected scene segment and to steer the reflection photons back to the PRX, and a closed loop controller to: (a) control the PTX, PRX and PSY, (b) receive the detected scene signal from the detector and (c) update the at least one pulse parameter and at least one detection parameter at least partially based on a scanning/work plan indicative of an estimated composition of scene elements present within the scene segment covered by the given set of inspection pulses, the work plan derived at least partially from the detected scene signal.

According to some embodiments, the steering assembly may be configured to direct and to steer in accordance with at least one adjustable steering parameter, determined by a work plan. The steering parameters may be selected from: transmission pattern, sample size of the scene, power modulation that defines the range accuracy of the scene, correction of axis impairments, dynamic FOV determination, scanning method, single or multiple deflection axis methods, synchronization components and more. The pulse parameter may be selected from: pulse power intensity, pulse width, pulse repetition rate, pulse sequence, pulse duty cycle, wavelength, phase and polarization and more. The detection parameter may be selected from: scanning direction, frame rate, ambient light effects, mechanical static and dynamic impairments, thermal effects and more. The work plan may be derived from a background model, a region of interest (ROI) model a region of non-interest (RONI) model and/or a host signal or otherwise. The steering parameter may be a field of view (FOV) determination. The detected scene signal may be characterized by an adjustable quality of service.

According to some embodiments, an autonomous vehicle may include a scanning device as discussed above and a host controller to receive the detected scene signal and to relay a host feedback to the scanning device including host ego-motion information. Ego-motion information may include: wheels steering position, vehicle speed, vehicle acceleration, vehicle braking, headlights status, turning lights status, GPS location information and more.

The work plan may be derived from a background model at least partially stored in the host controller and may be relayed to the scanning device via the host feedback. Optionally, the detected scene signal may be emitted in accordance with an adjustable quality of service.

According to some embodiments, a method of scanning a scene may include: emitting at least one pulse of inspection photons in accordance with at least one adjustable pulse parameter; detecting in accordance with at least one adjustable detection parameter reflected photons and producing a detected scene signal; estimating a scene composition of scene elements present within a scene segment and deriving a scanning plan at least partially from the detected scene signal, and updating at least one pulse parameter and at least one detection parameter at least partially based on the scanning plan.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C depict example monostatic and bistatic (appropriately) scanning device schematics in accordance with some embodiments;

FIG. 2 depicts an example scanning system in accordance with some embodiments;

FIG. 3 shows example inspection photon pulses control signals including example laser signals A, B and C;

FIGS. 4A-4F show schematics of different scanning plans which may be utilized to control pulse parameters and/or detector parameters and/or steering parameters and an identical key 402 for all of these figures;

FIG. 5A shows a schematic of a scene to be scanned by a scanning device in accordance with some embodiments;

FIG. 5B shows a chart of the power or resource allocation for the scene of FIG. 5A and a chart depicting interleaving of ROIs in power allocation over time in accordance with some embodiments;

FIG. 6 shows a flow chart of a method for avoiding exceeding a maximal reflected signal value by controlling the transmitted signal in accordance with some embodiments;

FIG. 7A shows an example scene which may include one or more background element in accordance with some embodiments;

FIG. 7B shows a flow chart associated with a system learning method for utilizing and updating a background model in accordance with some embodiments;

FIG. 8 shows two identical scenes in accordance with some embodiments;

FIG. 9A shows a FOV ratio including a maximal FOV and an active FOV;

FIGS. 9B&9C include example maximal and active FOVs in accordance with some embodiments; and

FIG. 10 shows a flow chart for scanning a scene in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

A scene scanning device has been discussed in detail in U.S. patent application Ser. No. 15/391,916 filed Dec. 28, 2016 titled “Methods Circuits Devices Assemblies Systems and Functionally Associated Machine Executable Code for Active Scene Scanning” of which application is hereby incorporated by reference into the present application in its entirety.

According to embodiments, there may be provided a scene scanning device adapted to inspect regions or segments of a scene using photonic pulses, which device may be a Lidar device. The photonic pulses used to inspect the scene, also referred to as inspection pulses, may be generated and transmitted with characteristics which are dynamically selected as a function of various parameters relating to the scene to be scanned and/or relating to a state, location and/or trajectory of the device. Sensing and/or measuring of characteristics of inspection pulse reflections from scene elements illuminated with one or more inspection pulses may also be dynamic and may include a modulating optical elements on an optical receive path of the device.

According to some embodiments, inspection of a scene segment may include illumination of the scene segment or region with a modulated pulse of photons, which pulse may have known parameters such as: pulse duration, pulse angular dispersion, photon wavelength, instantaneous power, photon density at different distances from the emitter and/or average power. Inspection may also include detecting and characterizing various parameters of reflected inspection photons, which reflected inspection photons are inspection pulse photons reflected back towards the scanning device from an illuminated element present within the inspected scene segment (i.e. scene segment element).

The definition of a scene according to embodiments of the present invention may vary from embodiment to embodiment, depending on the specific intended application of the invention. For Lidar applications, optionally used with a motor vehicle platform, the term scene may be defined as the physical space, up to a certain distance, surrounding the vehicle (in-front, on the sides, behind, below and/or above). A scene segment or scene region according to embodiments may be defined by a set of angles in a polar coordinate system, for example, corresponding to a diverging pulse or beam of light in a given direction. The light beam/pulse having a center radial vector in the given direction may also be characterized by broader defined angular divergence values, polar coordinate ranges of the light beam/pulse. Since the light beam/pulse produces an illumination area, or spot, of expanding size the farther out from the light source the spot hits a target, a scene segment or region being inspected at any given time, with any given photonic pulse, may be of varying and expanding dimensions. Accordingly, an inspection resolution of a scene segment may be reduced the further away illuminated scene segment elements are away from the active scene scanning device.

One of the critical tasks at hand for a scanning system is to observe the scene and understand semantics, such as drivable areas, obstacles, traffic signs and take vehicle control action upon them.

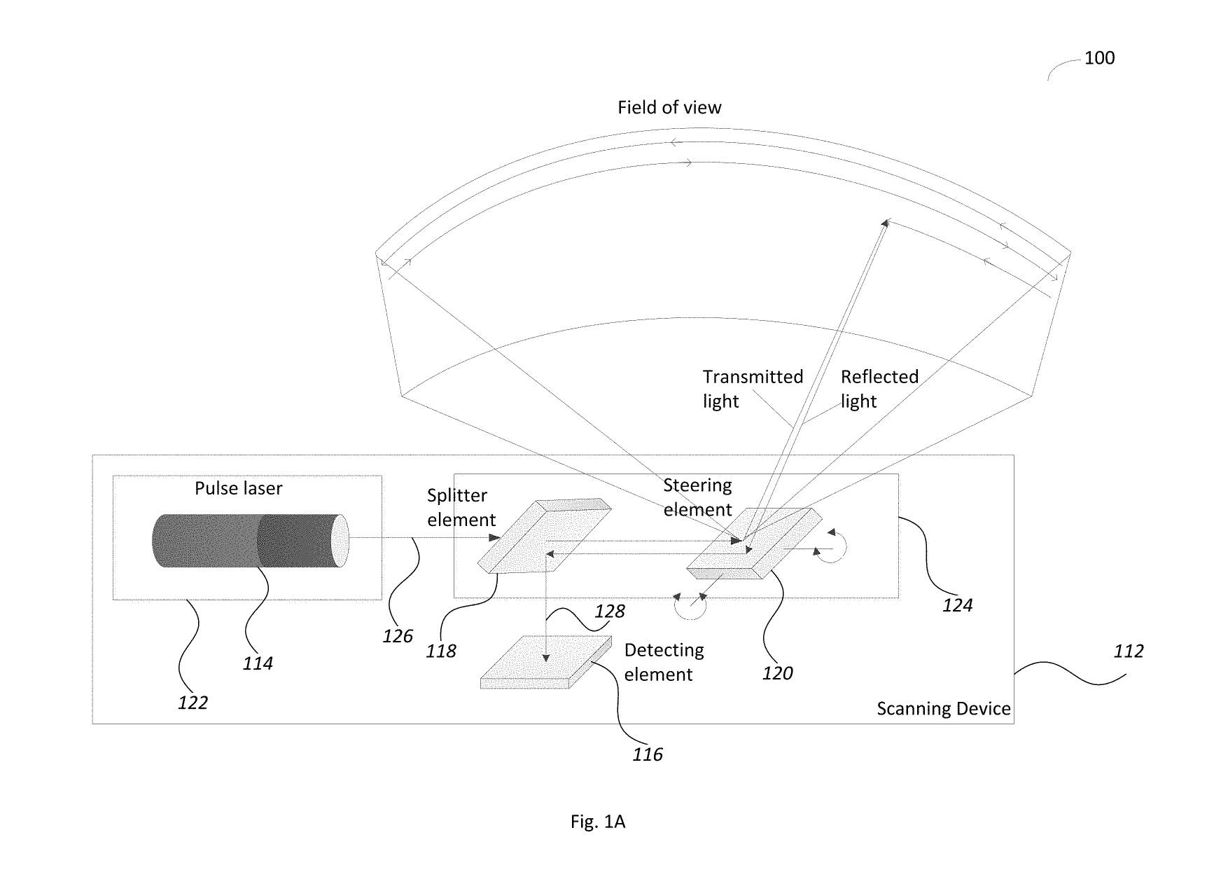

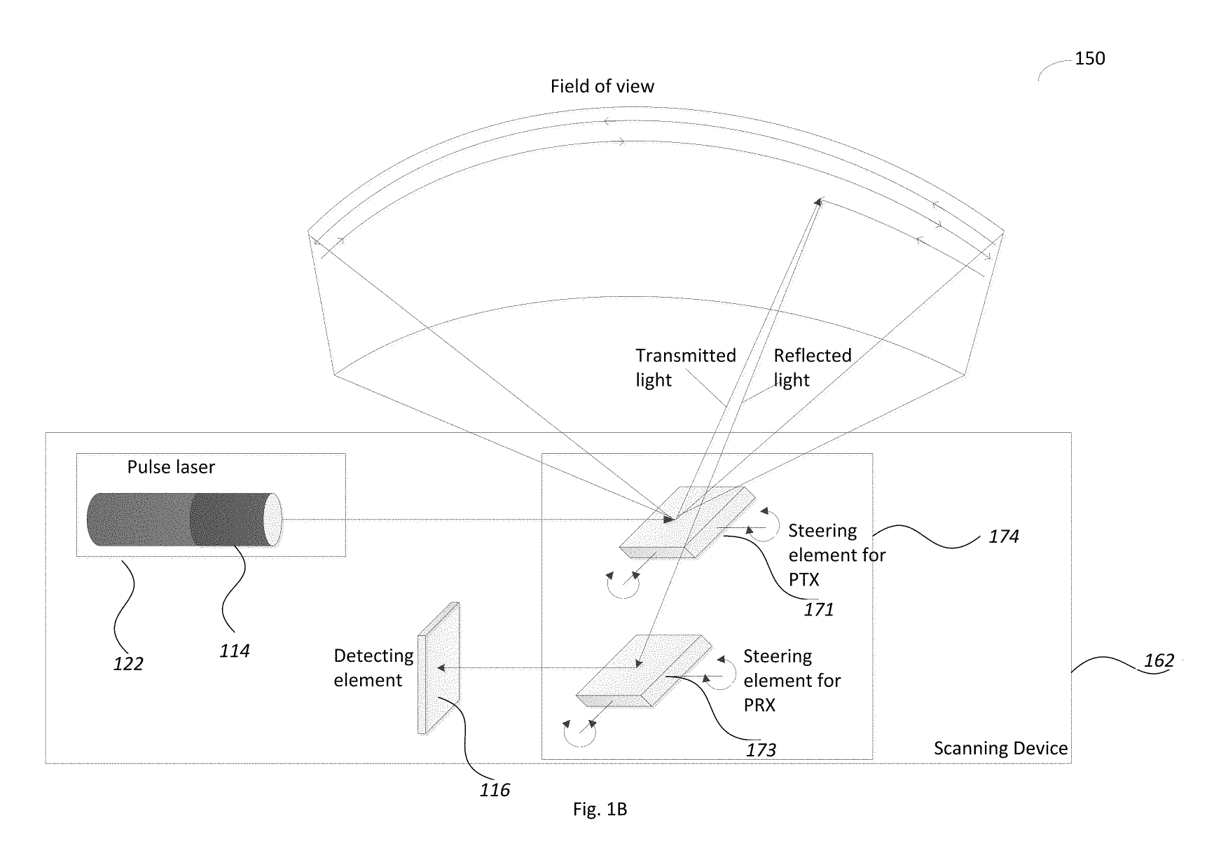

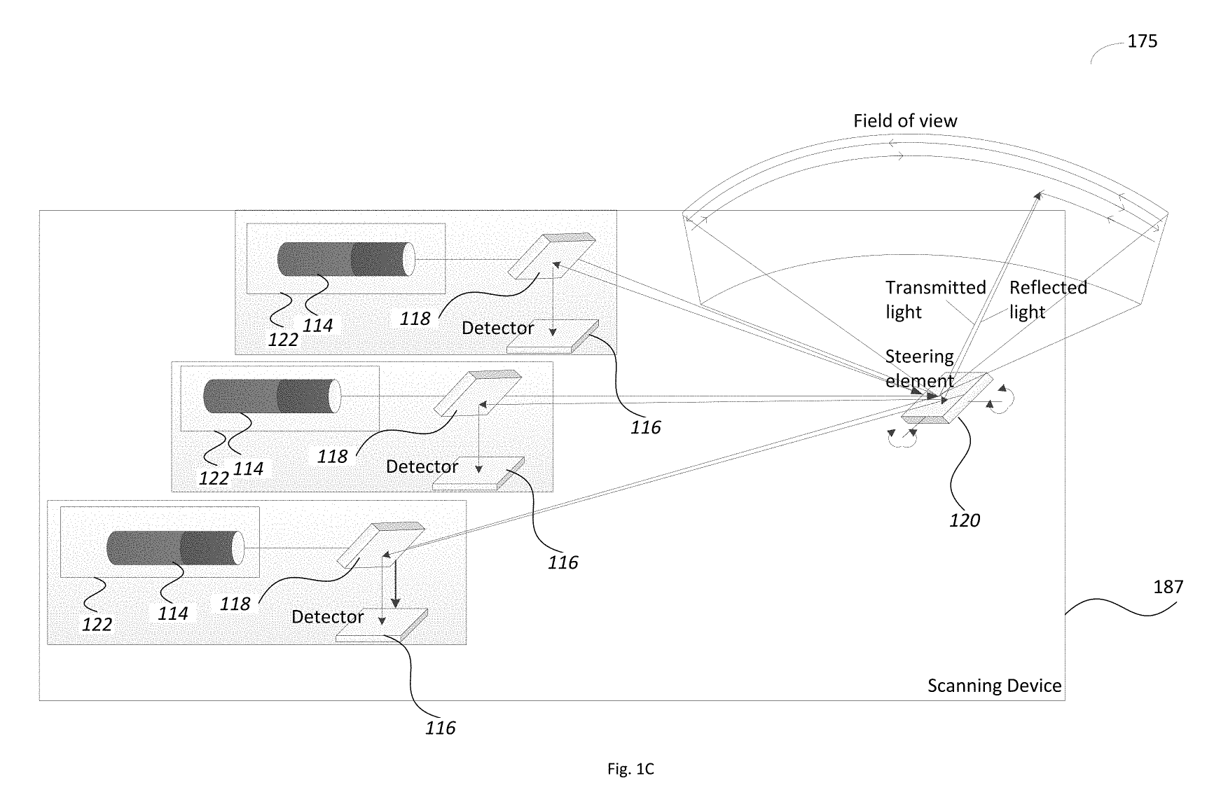

Turning to FIG. 1A, depicted is an example monostatic scanning device schematic 100. According to some embodiments, there may be provided a scene scanning device such as scanning device 112 which may be adapted to inspect regions or segments of a scene (shown here is a specific FOV being scanned) using photonic pulses (transmitted light) whose characteristics may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; (f) expected scene elements; (g) importance/priority of an expected scene element and/or (h) a situational feature/characteristic of a host platform with which the scanning device is operating. The scene scanning device may be adapted to inspect regions or segments of a scene using a set of one or more photonic transmitters 122 (including a light source such as pulse laser 114), receptors including sensors (such as detector assembly 116) and/or steering assembly 124; whose configuration and/or arrangement may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; (f) expected scene elements; (g) importance/priority of an expected scene element and/or (h) a situational feature/characteristic of a host platform with which the scanning device is operating. Active scanning device 112 may include: (a) a photonic transmitter 122 which produces pulses of inspection photons; (b) a photonic steering assembly 124 that directs the pulses of inspection photons to/from the inspected scene segment; (c) a photonic detector assembly 116 to detect inspection photons reflected back from an object within an inspected scene segment; and (d) a controller to regulate operation of the photonic emitter assembly, the photonic steering assembly and the operation of the photonic detection assembly in a coordinated manner and in accordance with scene segment inspection characteristics of the present invention at least partially received from internal feedback of the scanning device so that the scanning device is a closed loop dynamic scanning device. A closed loop scanning device is characterized by having feedback from at least one of the elements and updating one or more parameter of two or more scanning device blocks (photonic transmitters 122, steering assembly 124 and/or detector assembly 116) based on the received feedback. A closed loop system may receive feedback and update the systems own operation at least partially based on that feedback. A dynamic system or element is one that may be updated during operation.

According to some embodiments, inspection of a scene segment may include illumination of the scene segment or region with a pulse of photons (transmitted light), which pulse may have known parameters such as pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. Inspection may also include detecting and characterizing various aspects of reflected inspection photons, which reflected inspection photons are inspection pulse photons (reflected light) reflected back towards the scanning device (or laser reflection) from an illuminated element present within the inspected scene segment (i.e. scene segment element). Characteristics of reflected inspection photons may include photon time of flight (time from emission till detection), instantaneous power (or power signature) at and during return pulse detection, average power across entire return pulse and photon distribution/signal over return pulse period the reflected inspection photons are a function of the inspection photons and the scene elements they are reflected from and so the received reflected signal is analyzed accordingly. In other words, by comparing characteristics of a photonic inspection pulse with characteristics of a corresponding reflected and detected photonic pulse, a distance and possibly a physical characteristic such as reflected intensity of one or more scene elements present in the inspected scene segment may be estimated. By repeating this process across multiple adjacent scene segments, optionally in some pattern such as raster, lissajous or other patterns, an entire scene may be scanned in order to produce a map of the scene.

Scanning device 112 may have hierarchical FOV perception capabilities that can be shifted in space and time. These capabilities may enable high performance LiDAR across a very large FOV area by adaptive partitioning into segments of FOVs that are allocated a certain level of quality of service (QoS). It is typically impossible to assign the highest QoS for all segments, therefore the need for an adaptive allocation method will be henceforth described. QoS depends on the signal to noise ratio between the laser pulse transmitted 126 and the laser reflection detected 128 from the target reflection. Different levels of laser power may be applied in different regions in the LiDAR FOV. The levels of power may range from zero up to the maximum power that the laser device is capable of transmitting and/or receiving. QoS has limitations stemming from physical design, eye safety, thermal constraints, cost and form factor and more. Accordingly, scanning device 112 may be limited by one or more of the following system and/or scene features: horizontal and vertical FOV range; data acquisition rate (e.g. frame rate); resolution (e.g. number of pixels in a frame); accuracy (spatial and temporal); range (effective detection distance) and more.

According to some embodiments, scanning device 112 may be assembled and fixed on a vehicle in constrained locations which may cause a fixed boresight. For this and additional reasons, scanning device 112 may be “observing” the FOV of the driving scene in a sub-optimal manner. Scanning device 112 may experience obstructing elements in the vehicle assembly as well as sub-optimal location in relation to the vehicle dimensions and aspect ratio and more.

Typically, laser power allocation affects data frame quality which is represented by the following parameters: range of target, frame rate and/or FOV and spatial resolution. With regard to range of target—the farther the target within FOV, the longer the path the laser pulse has to travel and the larger the laser signal loss. A far target will require a higher energy laser pulse than a close target in order to maintain a certain signal to noise ratio (SNR) that is required for optimal detection of the target. The laser energy may be achieved by modulating the laser pulse transmitted 126 for example: by appropriately controlling the laser light pulse width and the laser light pulse repetition rate. With regard to FOV and spatial resolution: the number of data elements (e.g. 3D or 4D pixels) in a frame combined with the FOV define the size of the frame. The more data elements in a frame, the more laser energy that has to be spent in order to acquire more data scanning device 112 surroundings. Doubling the resolution and the FOV, for example, would result in doubling the laser energy spent in order to acquire double the size of the data set. With regard to frame rate: higher frame rate implies that the laser may be illuminating a certain target within the FOV at a higher rate and therefore more energy is also spent in this case.

Turning to FIG. 1B, depicted is an example bistatic scanning device schematic 150. It is understood that scanning device 162 is substantially similar to scanning device 112. However, scanning device 112 is a monostatic scanning device while scanning device 162 is a bi static scanning device. Accordingly, steering element 174 is comprised of two steering elements: steering element for PTX 171 and steering element for PRX 173. The rest of the discussion relating to scanning device 112 of FIG. 1A is applicable to scanning device 162 FIG. 1B.

Turning to FIG. 1C, depicted is an example scanning device schematic 175 with a plurality of photonic transmitters 122 and a plurality of splitter elements 118 and a plurality of detector assemblies 116. All of the transmitters 122, detectors, 116 and splitters 118 may have a joint steering element 120. It is understood that scanning device 187 is substantially similar to scanning device 112. However, scanning device 187 is a monostatic scanning device with a plurality of transmitting and receiving elements. The rest of the discussion relating to scanning device 112 of FIG. 1A is applicable to scanning device 187 FIG. 1C.

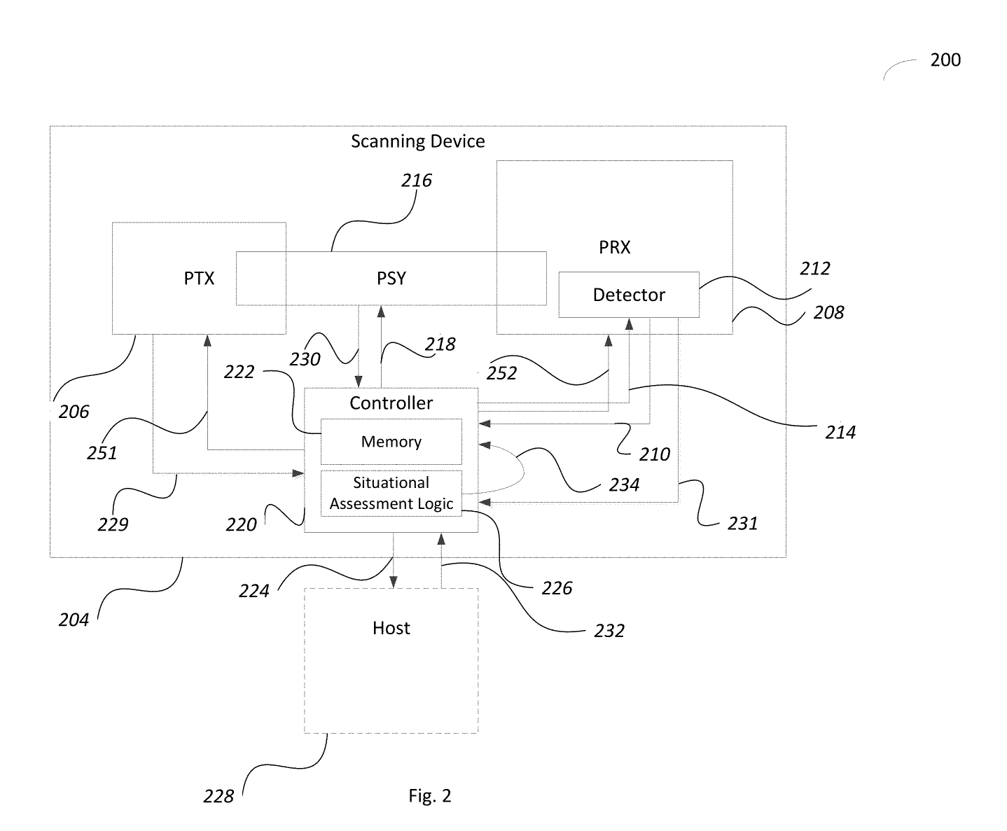

Turning to FIG. 2, depicted is an example scanning system 200 in accordance with some embodiments. Scanning system 200 may include a scene scanning device such as scanning device 204 adapted to inspect regions or segments of a scene using photonic pulses which may be emitted in accordance with dynamically selected parameters. Scanning device 204 may be configured to operate in conjunction with a host device, such as host 228 which may be part of the system 200 or associated with the system 200. Scanning device 204 may be an example embodiment for scanning device 112 of FIG. 1A, scanning device 162 of FIG. 1B and/or scanning device 187 of FIG. 1C and the discussion of those scanning devices is applicable to scanning device 204.

According to some embodiments, scanning device 204 may include a photonic emitter assembly (PTX) such as PTX 206 to produce pulses of inspection photons. PTX 206 may include a laser or alternative light source. The light source may be a laser such as a solid state laser, a high power laser or otherwise or an alternative light source such as, a LED based light source or otherwise.

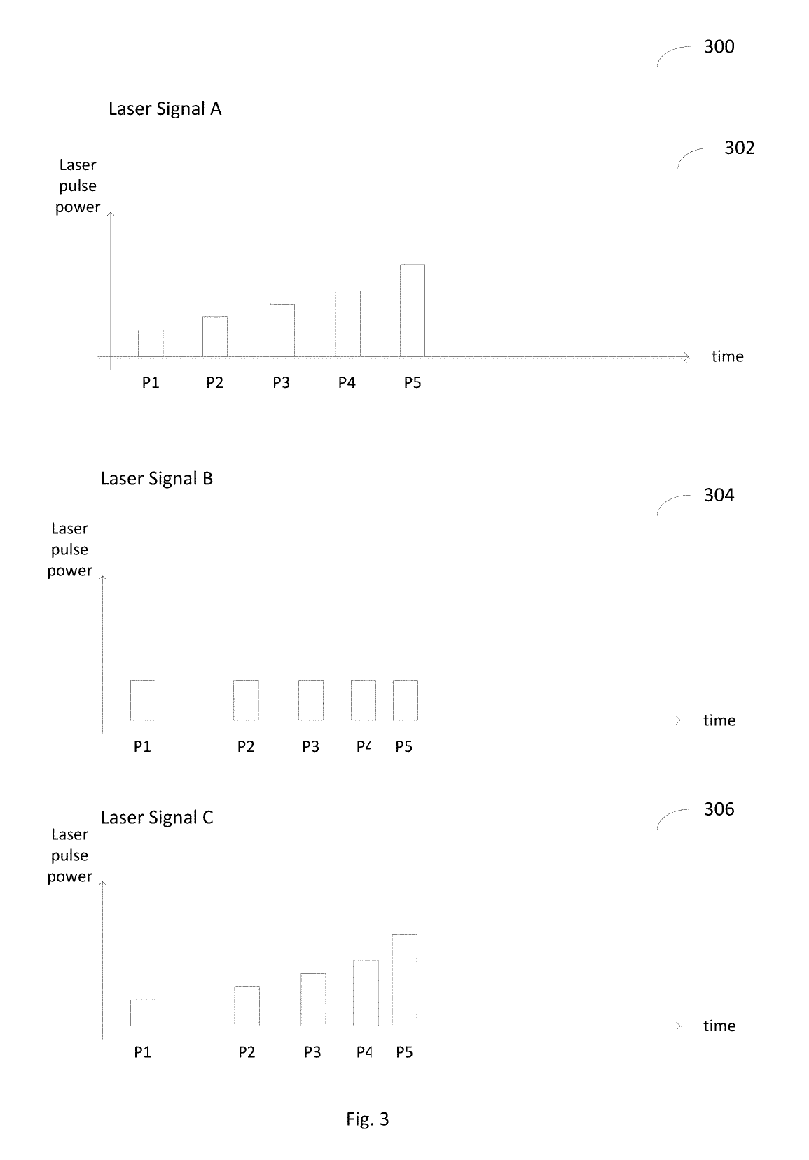

According to some embodiments, the photon pulses may be characterized by one or more controllable pulse parameters such as: pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. The inspection photons may be controlled so that they vary in pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. The photon pulses may vary between each other and the parameters may change during the same signal. The inspection photon pulses may be pseudo random, chirp sequence and/or may be periodical or fixed and/or a combination of these. The inspection photon pulses may be characterized as: sinusoidal, chirp sequences, step functions, pseudo random signals, or linear signals or otherwise. Examples are shown in FIG. 3 which depicts example inspection photon pulses control signals 300 including examples laser signal A (302); laser signal B (304) and laser signal C (306) depicting the control signal enabling a photon pulse and determining the intensity, width, repetition rate of the pulse as well as pulse repetition rate and/or pulse sequence. Laser signal A 302, for example, is characterized by increased power pulses, this type of sequence may be applicable to cover targets at increased ranges. Laser signal B 304, for example, is characterized by a chirp pulse position modulation and may be applicable for increased SNR. Laser signal C 306 may be characterized by a combination of chirp pulse position modulation and increased power range applicable for both increased range and increased SNR.

Returning to FIG. 2, according to some embodiments PTX 206 laser may operate in different laser modes such as modulated continuous wave (CW), pulsed quasi CW (Q-CW), mode locked, and may include a plurality of laser emitters.

According some embodiments, PTX 206 may include additional elements such as a collimator to compensate for divergence effects of the laser emitter and render the beam into an optimal shape suitable for steering, transmission and detection. PTX 206 may also include a thermoelectric cooler to optimize temperature stabilization as solid state lasers, for example, may experience degradation in performance with temperature increase, so cooling the laser may enable a higher power yield. PTX 206 may also include an optical outlet.

According to some embodiments, PTX 206 may include one or more PTX state sensors to produce a signal indicating an operational state of PTX 206 which may include information such as PTX power consumption, temperature, laser condition and more.

According to some embodiments, scanning device 204 may include a photonic reception and detection assembly (PRX) such as PRX 208 to receive reflected photons reflected back from an object or scene element and produce detected scene signal 210. PRX 208 may include a detector such as detector 212. Detector 212 may be configured to detect the reflected photons reflected back from an object or scene element and produce detected scene signal 210.

According to some embodiments, detected scene signal 210 may include information such as: time of flight which is indicative of the difference in time between the time a photon was emitted and detected after reflection from an object, reflected intensity, polarization values and more.

According to some embodiments, detected scene signal 210 may be represented using point cloud, 3D signal or vector, 4D signal or vector (adding time to the other three dimensions) and more.

According to some embodiments, detector 212 may have one or more updatable detector parameters controlled by detector parameters control 214 such as: scanning direction, frame rate, ambient light effects, mechanical static and dynamic impairments, thermal effects, wear and tear, area of interest, resolution, sensitivity and more. Detector parameters control 214 may be utilized for dynamic operation of detector 212, for example, scanning direction may be utilized for dynamic allocation of detector power/resolution/sensitivity/resources. Scanning direction may be the expected direction of the associated inspection photons, frame rate may be the laser or PRX's frame rate, ambient light effect may include detected noise photons or expected inspection photons (before they are reflected), mechanical impairments may also be correlated to issues deviation of other elements of the system that need to be compensated for, knowledge of thermal effects may be utilized to reduce signal to noise ratio, wear and tear refers to wear and tear of detector 212 and/or other blocks of the system that detector 212 can compensate for, area of interest may be an area of the scanned scene that is more important and more. Ambient conditions such as fog/rain/smoke impact signal to noise (lifting the noise floor) can be used as a parameter that defines the operating conditions of detector 212 and also laser of PTX 206. Another critical element is the gating of detector 212 in a monostatic design example embodiment thus avoiding the blinding of detector 212 with the initial transmission of the laser pulse, or due to any other example TX/RX co-channel interference.

According to some embodiments, detector 212 may include an array of detectors such as an array of avalanche photo diodes (APD), single photon detection avalanche diodes (SPADs) or a single detecting elements that measure the time of flight from a laser pulse transmission event to the reception event and the intensity of the received photons. The reception event is the result of the laser pulse being reflected from a target in the FOV present at the scanned angular position of the laser of PTX 206. The time of flight is a timestamp value that represents the distance of the reflecting target, object or scene element to scanning device 204. Time of flight values may be realized by photon detection and counting methods such as: TCSPC (time correlated single photon counters), analog methods for photon detection such as signal integration and qualification (via analog to digital converters or plain comparators) or otherwise.

According to some embodiments, detector 212 may include a full array of single photon detection avalanche diodes which may be partitioned into one or more pixels that capture a fragment of the FOV. A pixel may represent the basic data element that build up the captured FOV in the 3 dimensional space (e.g. the basic element of a point cloud representation) including a spatial position and the reflected intensity value

According to some optional embodiments of detector 212 may include: (a) a two dimensional array sized to capture one or more pixels out of the FOV, a pixel window may contain a fraction of a pixel, one or more pixels or otherwise; (b) a two dimensional array that captures multiple rows or columns in a FOV up to an entire FOV; (c) a single dimensional array and/or (d) a single SPAD element or otherwise.

According to some embodiments, PRX 212 may also include an optical inlet which may be a single physical path with a single lens or no lens at all.

According to some embodiments, PRX 212 may include one or more PRX state sensors to produce a signal indicating an operational state of PRX 212 for example power information or temperature information, detector state and more.

According to some embodiments, scanning device 204 may be a bi static scanning device where PTX 206 and PRX 208 have separate optical paths or scanning device 204 may be a monostatic scanning system where PTX 206 and PRX 208 have a joint optical path.

According to some embodiments, scanning device 204 may include a photonic steering assembly (PSY), such as PSY 216, to direct pulses of inspection photons from PTX 206 in a direction of an inspected scene and to steer reflection photons from the scene back to PRX 208. PTX 216 may also be in charge of positioning the singular scanned pixel window onto/in the direction of detector 212.

According to some embodiments, PSY 216 may be a joint PSY, and accordingly, may be joint between PTX 206 and PRX 208 which may be a preferred embodiment for a monostatic scanning system

According to some embodiments, PSY 216 may include a plurality of steering assemblies or may have several parts one associated with PTX 216 and another associated with PRX 208.

According to some embodiments PSY 216 may be a dynamic steering assembly and may be controllable by steering parameters control 218. Example steering parameters may include: scanning method that defines the acquisition pattern and sample size of the scene, power modulation that defines the range accuracy of the acquired scene, correction of axis impairments based on collected feedback.

According to some embodiments PSY 216 may include: (a) a Single Dual-Axis MEMS mirror; (b) a dual single axis MEMS mirror; (c) a mirror array where multiple mirrors are synchronized in unison and acting as a single large mirror; (d) a mirror splitted array with separate transmission and reception and/or (e) a combination of these and more.

According to some embodiments, if PSY 216 includes a MEMS splitted array the beam splitter may be integrated with the laser beam steering. According to further embodiments, part of the array may be used for the transmission path and the second part of the array may be used for the reception path. The transmission mirrors may be synchronized and the reception mirrors may be synchronized separately from the transmission mirrors. The transmission mirrors and the reception mirrors sub arrays maintain an angular shift between themselves in order to steer the beam into separate ports, essentially integrating a circulator module.

According to some embodiments, PSY 216 may include one or more PSY state sensors which may at least partially be used for producing a signal indicating an operational state of PSY 216 such as PSY feedback 230 which may include power information or temperature information, reflector state, reflector actual axis positioning, reflector mechanical state, operational health state and more.

According to some embodiments, PSY 216 may also include a circulator Model/Beam splitter, although it is understood that the splitter may also be part of PRX 208 instead. The beam splitter may be configured to separate the transmission path of PTX 206 from the reception path of PRX 208. In some embodiments the beam splitter may either be integrated in the steering assembly (for example if a splitter array is utilized) or may be redundant or not needed and accordingly the scanning device may not include a beam splitter.

According to some embodiments, the beam splitter of PSY 216 may be a polarized beam splitter (PBS), a slitted PBS (polarizing beam splitter) integrating a mirror and a quarter wave plate, circulator beam splitter and/or a slit based reflector or otherwise.

According to some embodiments, PSY 216 may include one or more reflective surfaces, each of which reflective surface may be associated to an electrically controllable electromechanically actuator. The reflective surface(s) may be made from polished gold, aluminum, silicon, silver, or otherwise. The electrometrical actuator(s) may be selected from actuators such as stepper motors, direct current motors, galvanometric actuators, electrostatic, magnetic or piezo elements or thermal based actuators. PSY 216 may include or be otherwise associated with one or more microelectromechanical systems (MEMS) mirror assemblies. A photonic steering assembly according to refractive embodiments may include one or more reflective materials whose index of refraction may be electrically modulated, either by inducing an electric field around the material or by applying electromechanical vibrations to the material.

According to yet further embodiments, the PSY 216 may include a beam splitter to help separate transmission path from the reception path. Using the same photonic steering assembly may provide for tight synchronization between a direction in which a photonic pulse/beam is steered and emitted by the photonic emitter assembly and a direction of a concurrent FOV of one or more optical sensors of the photonic detection assembly. Shared photonic steering assembly configuration may allow for a photonic detector assembly of a given device to focus upon and almost exclusively to collect/receive reflected photons from substantially the same scene segment being concurrently illuminated by the given device's photonic emitter assembly. Accordingly, as the photonic steering assembly moves, so does the photonic pulse illumination angle along with the FOV angle.

According to some embodiments, scanning device 204 may include a controller to control scanning device 204, such as controller 220. Controller 204 may receive scene signal 210 from detector 212 and may control PTX 206, PSY 218 PRX 208 including detector 212 based on information stored in the controller memory 222 as well as received scene signal 210 including accumulated information from a plurality of scene signals 210 received over time.

According to some embodiment, SAL 226 may receive a PTX feedback 229 indicating PTX associated information such as power consumption, temperature, laser operational status, actual emitted signal and more.

According to some embodiment, SAL 226 may receive a PRX feedback 231 indicating PRX associated information such as power consumption, temperature, detector state feedback, detector actual state, PRX operational status and more.

According to some embodiment, SAL 226 may receive a PSY feedback 230 indicating PSY associated information such as power consumption, temperature, instantaneous position of PSY 218, instantaneous scanning speed of PSY 218, instantaneous scanning frequency of PSY 218, mechanical overshoot of PSY 218, PSY operational status and more.

According to some embodiments, SAL 226 may receive a host information and feedback signal such as host feedback 232 which may include information received from the host. Host feedback may include information from other sensors in the system such other LiDARs, camera, RF radar, acoustic proximity system and more.

According to some embodiments, controller 220 may process scene signal 210, optionally, with additional information and signals and produce a vision output such as vision signal 234 which may be relayed/transmitted/to an associated host device. Controller 220 may receive detected scene signal 210 from detector 212, optionally scene signal 210 may include time of flight values and intensity values of the received photons. Controller 220 may build up a point cloud or 3D or 2D representation for the FOV by utilizing digital signal processing, image processing and computer vision techniques.

According to some embodiments, controller 220 may include situational assessment logic or circuitry such as situational assessment logic (SAL) 226. SAL 126 may receive detected scene signal 210 from detector 212 as well as information from additional blocks/elements either internal or external to scanning device 204 such as PTX feedback 229, PSY feedback 230, PRX feedback 231, host feedback 232 and more

According to some embodiments, scene signal 210 can be assessed and calculated with or without additional feedback signals such as a PSY feedback 230, PTX feedback 229, PRX feedback 231 and host feedback 232 and information stored in memory 222 to a weighted means of local and global cost functions that determine a scanning plan such as work plan signal 234 for scanning device 204 (such as: which pixels in the FOV are scanned, at which laser parameters budget, at which detector parameters budget). Controls such as PTX control signal 251, steering parameters control 218, PRX control 252 and/or detector parameters control 214 may be determined/updated based on work plan 234. Accordingly, controller 220 may be a closed loop dynamic controller that receives system feedback and updates the system's operation based on that feedback.

According to some embodiments of the present invention, there may be provided a scanning device for scanning one or more segments of a scene, also referred to as scene segments. The device may include one or more photonic emitter assemblies (PTX), one or more photonic reception and detection assemblies (PRX), a photonic steering assembly (PSY) and a situationally aware controller adapted to synchronize operation of the PTX, PRX and PSY, such that the device may dynamically perform active scanning of one or more scene segments, or regions, of a scene during a scanning frame. Active scanning, according to embodiments may include transmission of one or more photonic inspection pulses towards and across a scene segment, and when a scene element present within the scene segment is hit by an inspection pulse, measuring a roundtrip time-of-flight for the pulse to hit the element and its reflections to return, in order to estimate a distance and a (relative) three dimensional coordinate of point hit by the inspection pulse on the scene element. By collecting coordinates for a set of points on an element, using a set of inspection pulses, a three dimensional point cloud may be generated and used to detect, register and possibly identify the scene element.

The controller may be a situationally aware controller and may dynamically adjust the operational mode and operational parameters of the PTX, PRX and/or PSY based on one or more detected and/or otherwise known scene related situational parameters. According to some embodiments, the controller may generate and/or adjust a work plan such as scanning plan 234 for scanning portions of a scene, as part of a scanning frame intended to scan/cover one or more segments of the scene, based on an understanding of situational parameters such as scene elements present within the one or more scene segment. Other situational parameters which may be factored in generating the scanning plan may include a location and/or a trajectory of a host platform carrying a device according to embodiments. Yet further situational parameters which may be factored in generating the scanning plan may include a topography, include road slope, pitch and curvature, surrounding a host platform carrying a device according to embodiments.

Scanning plan 234 according to embodiments may include: (a) a designation of scene segments within the scene to be actively scanned as part of a scanning frame, (b) an inspection pulse set scheme (PSS) which may define a pulse distribution pattern and/or individual pulse characteristics of a set of inspection pulses used to scan at least one of the scene segments, (c) a detection scheme which may define a detector sensitivity or responsivity pattern, (d) a steering scheme which may define a steering direction, frequency, designate idle elements within a steering array and more. In other words, scanning plan 234 may at least partially affect/determine PTX control signal 251, steering parameters control 218, PRX control 252 and/or detector parameters control 214 so that a scanning frame is actively scanned based on scene analysis.

According to some embodiments, scene related situational parameters factored in formulating work plan 234 may come from: (a) Localized output of a shared/pre-stored background model (Background, Topography, Road, Landmarks, etc.) (b) Localization Using GPS, Terrestrial Radio Beacons, INS, Visual landmark detection (c) Accelerometer, Gravity Meter, etc. (d) Acquired background model (Background/Topology detection using camera and/or active (Lidar) scanning) (e) Active (Lidar) Foreground Scanning (f) Camera Based Feature/Element Detection/Registration (g) Host platform sensor such as camera, radar outputs (h) Host Ego-motion information such as wheels steering position, speed, acceleration, braking, headlights, turning lights, GPS and more (i) other LiDAR components in the system and (j) ROI and/or RONI models.

According to some embodiments, factors in formulating/generating/adjusting work plan 234 may include: (a) Host location and/or trajectory; (b) Terrain (such as road features and delimiters, static features such as trees, buildings, bridges signs and landmarks and more) (c) Background Elements (assumed and detected) (d) Foreground Elements' (Detected) Location and Trajectory and more.

According to some embodiments, work plan 234 may determine or cause the FOV to be modified/determined. Scanning device 204 can change its reference or nominal FOV observation by modifying, for example, the boresight reference point of sight. A solid state Lidar, if incorporated in scanning device 204 may control the boresight reference point in space while maintaining the same FOV, a feature not feasible with fixed FOV Lidar devices.

According to some embodiments, SAL 226 may determine scanning plan 234 at least partially by determining/detecting/receiving regions of interest within the FOV and regions of non-interest within the FOV. Regions of interest may be sections/pixels/elements within the FOV that are important to monitor/detect, for example, areas which may be marked as regions of interest may include, crosswalks, moving elements, people, nearby vehicles and more. Regions of non-interest may be static (non-moving) far-away buildings, skyline and more.

According to some embodiments, scanning plan 234 may control one or more control signals including: PTX control 251, PSY control 218, PRX control 252 and/or detector control 214. The control signals may be utilized for (a) laser power scheduling to allocate laser power for each element or tri-dimensional pixel of a frame that is in the process of acquisition of scheduled for acquisition; (b) laser pulse modulation characteristics such as duration, rate, peak and average power, spot shape and more; (c) detector resources allocation for example to activate detector elements where a ROI is expected and disable detector elements where regions of non-interest are expected to reduce noise, detector sensitivity such as high sensitivity for long range detection where the reflected power is low, detector resolution such as long range detection with a weak reflected signal may result in averaging of multiple detector elements otherwise serving as separate higher resolution pixels; (d) updating steering parameters to scan an active FOV.

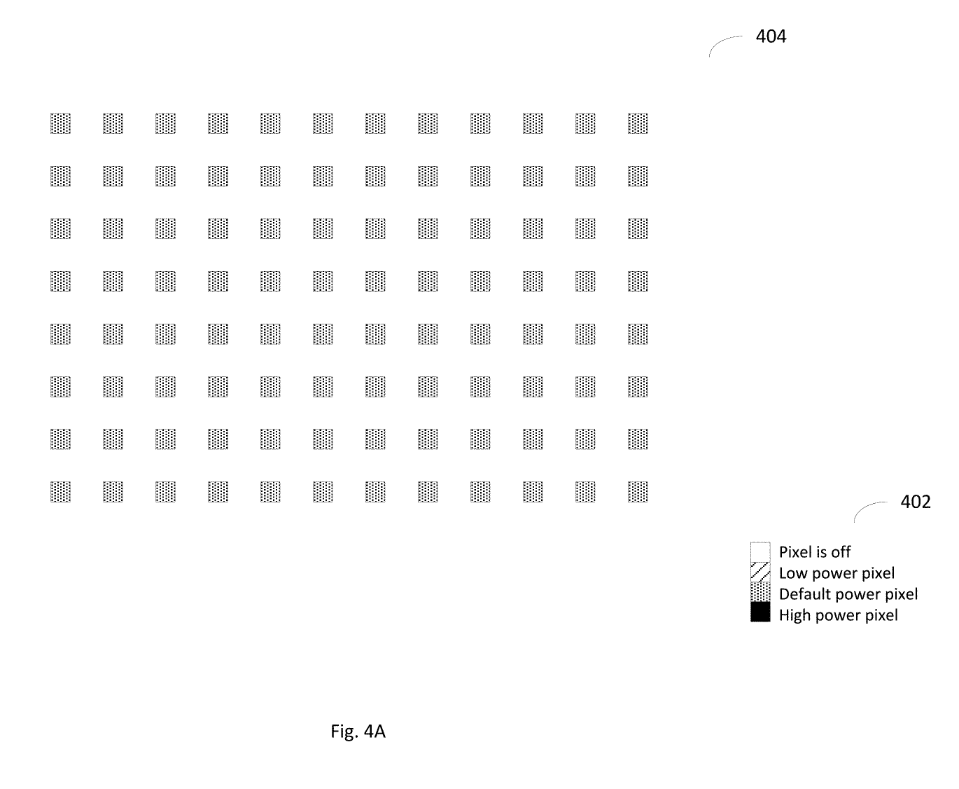

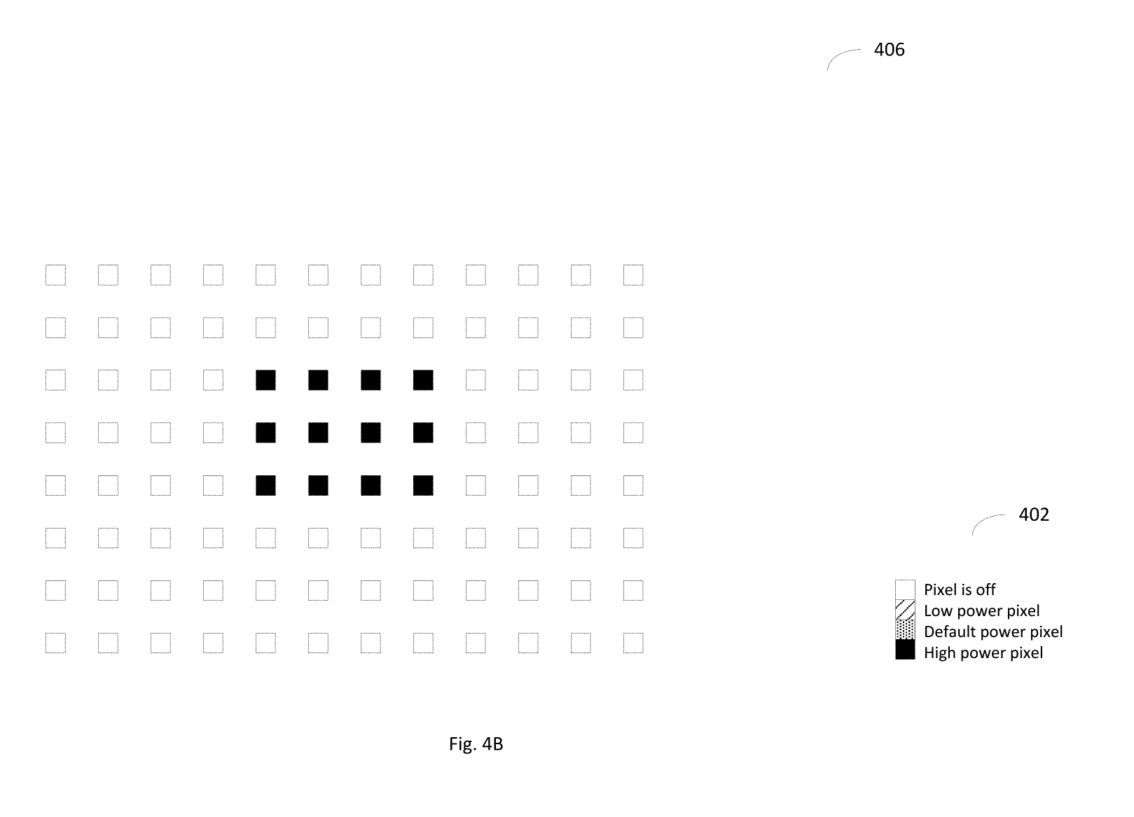

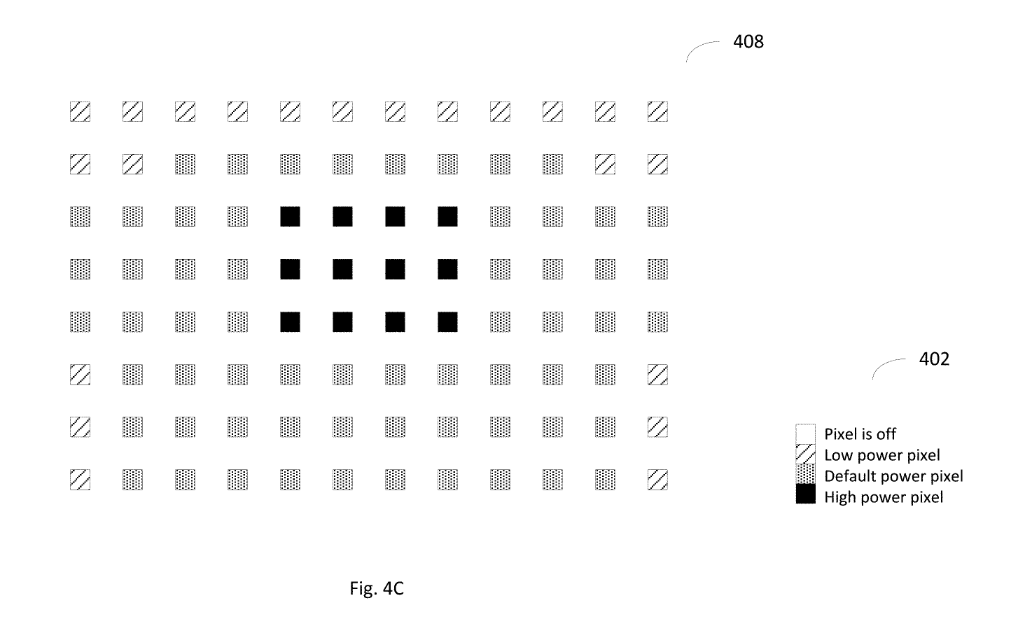

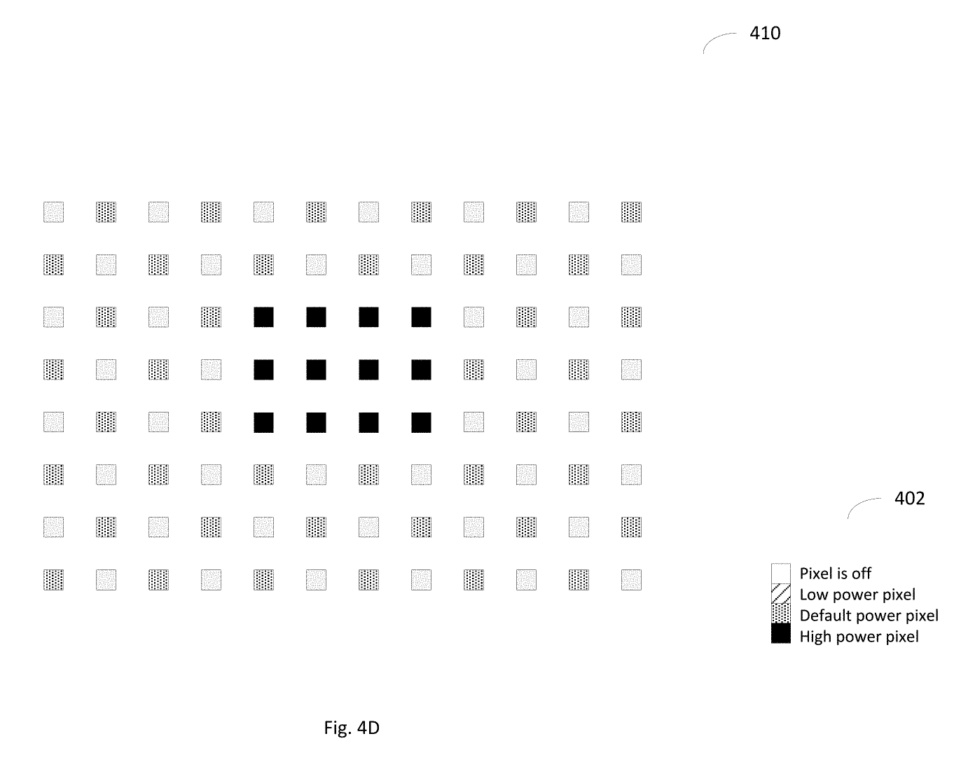

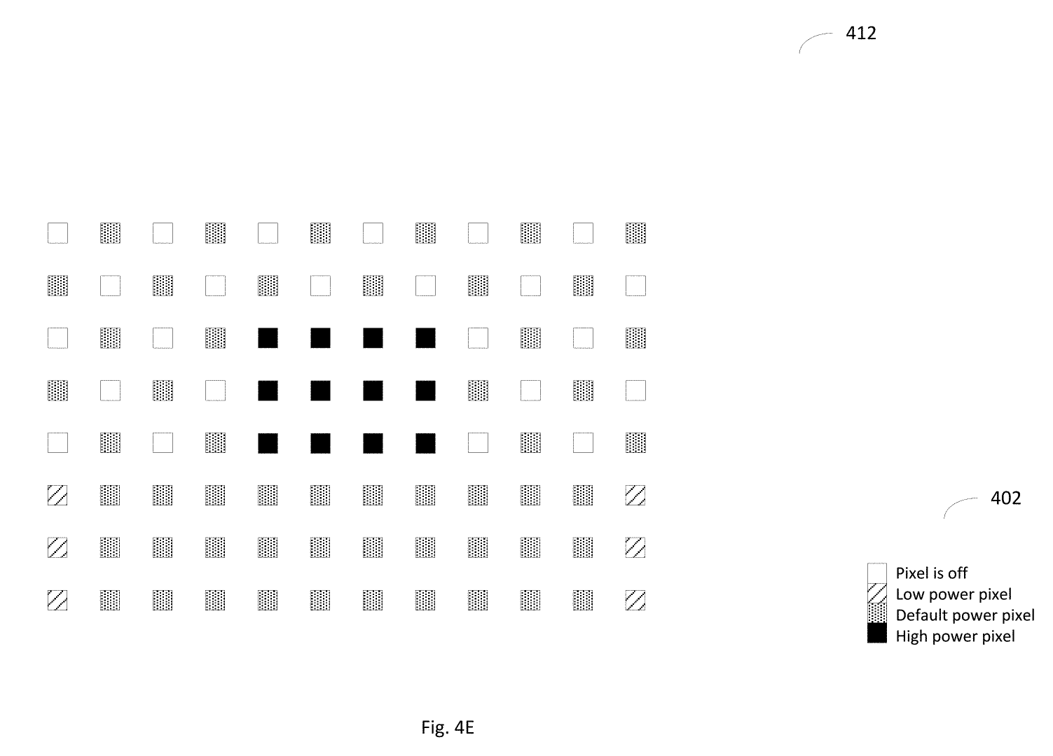

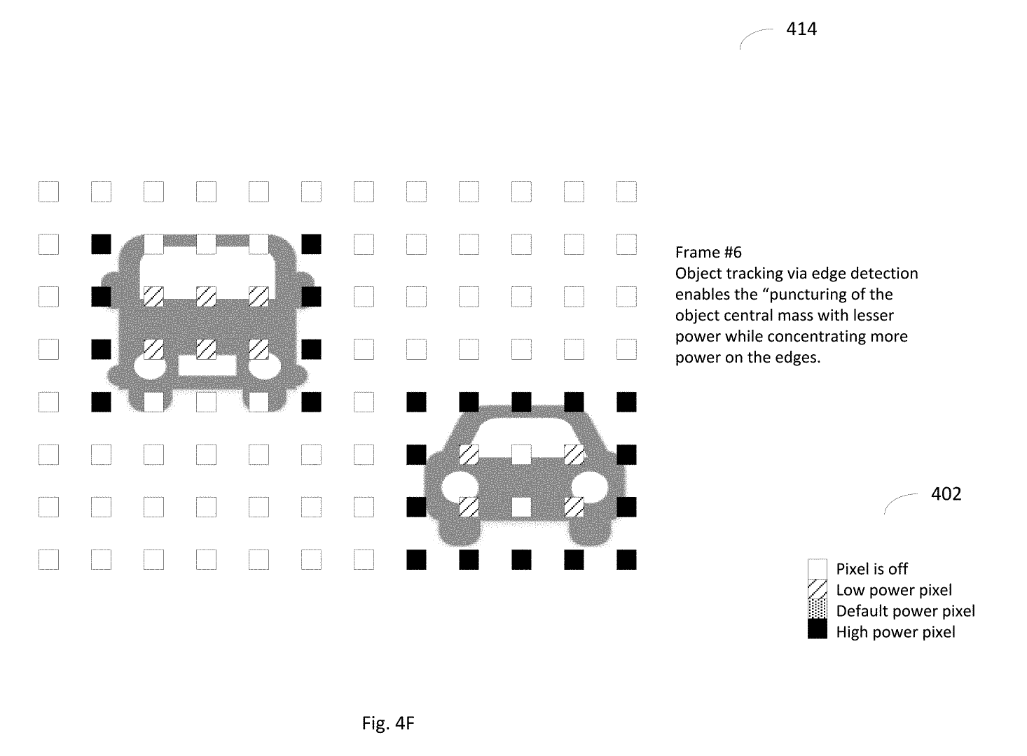

Turning to FIGS. 4A-4F shown are schematics depicting scanning plans which may be utilized to control pulse parameters and/or detector parameters and/or steering parameters using an identical key 402 for all of these figures. FIG. 4A depicts a first frame 404 wherein all of the pixels are of the same importance/priority having a default power allocated to them, this may, for example be utilized in a start-up phase or periodically interleaved in a scanning plan to monitor the whole frame for unexpected/new elements. According to scanning plan depicted in 404 the pulse parameters may be configured to have a constant amplitude.

Turning to FIG. 4B, depicted is a second frame 406 which may be a partial pixel frame, a section of frame 402 is configured to have a high power while the rest of the frame may be configured to have no power. The pixels having maximal power may be a ROI. The resulting frame may have a low number of pixels enable a high range in the ROI due to concentration of laser power. According to the scanning plan depicted in 406 the pulse parameters may, for example, be configured to have a high amplitude only in the ROI and no power steered in the RONI. A steering device may be utilized to deflect the signal only in the ROI and/or a detector may be configured to receive a signal only where the ROI is expected to be received to avoid any noise for the pixels that have no power.

Turning to FIG. 4C, depicted is a third frame 408 which may be characterized in that all the pixels have a power allocation according to the ROI designation. So the most interesting/important regions may have the highest power and so on.

Turning to FIG. 4D, depicted is a fourth frame 410 which is characterized in a range of different powered pixels. The ROI in the center is allocated with maximal power while the lower interest region has a default power in a lower spatial resolution which is a different way of receiving information for a RONI or region of lower interest. According to the scanning plan depicted in 410 the pulse parameters may be configured to have a high amplitude in the ROI and a lower amplitude with a lower frequency may be utilized for the other pixels. Furthermore, the detector may be turned off in the turned off pixels and steering parameter may be modified, for example, for rows that do not have a ROI in them.

Turning to FIG. 4E shown is a fifth frame 412 which is characterized as having a variable resolution, variable power/range. The ROI, in this example, has high resolution and high power, additional pixels at default power, low power pixels and lower spatial resolution.

Turning to FIG. 4F shown is a sixth frame 414 which includes a compact vehicle and a bus (see silhouettes) the edges of the vehicle and bus may be tracked with high power and the central mass of the vehicle and bus may be allocated lesser power (or no power). Such power allocation enables concentrating more power on the edges and less on the center which has less importance.

Turning back to FIG. 3, and as shown in the previous frame examples, scanning plan 234 may dynamically allocate laser, detector and steering resources towards regions of interest/non-interest based on several strategies.

In a first example, if no power is scheduled for one or more frames the pixel may be skipped (by not allocating laser power, by disabling reflection toward the scene and/or by disabling the detector or otherwise). This example may be utilized for a center pixel in a tracked vehicle that would be considered much less interesting than the edge pixels of the same vehicle (see also discussion of FIG. 4F).

In a second example, power may be scheduled (by allocating laser power, by enabling reflection towards and from the pixel and by determining an efficient detector accuracy) for predicted locations of vertical edges of a building or the predicted location of a vehicle in motion that quickly changes lanes of the edges of the FOV that coincide with the host vehicle turning in a certain direction.

According to some embodiments, laser power may be scheduled periodically over one or more time related sequence (full frames, partial frames) in order to acquire non-deterministic data. Periodicity may be determined by prediction estimation quality factors. For example, a region may be consider noisy having a lot of movement and accordingly may be checked (i.e. may be scanned or may be scanned with more accuracy) more frequently than an area designated as static background.

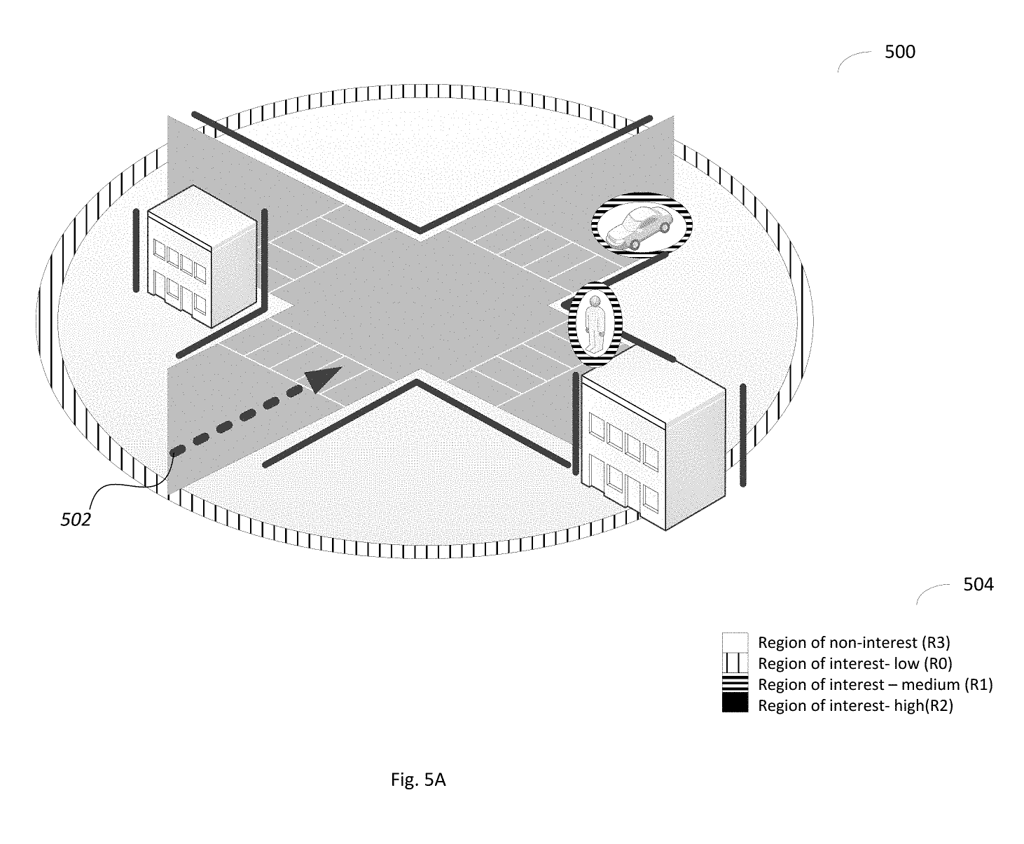

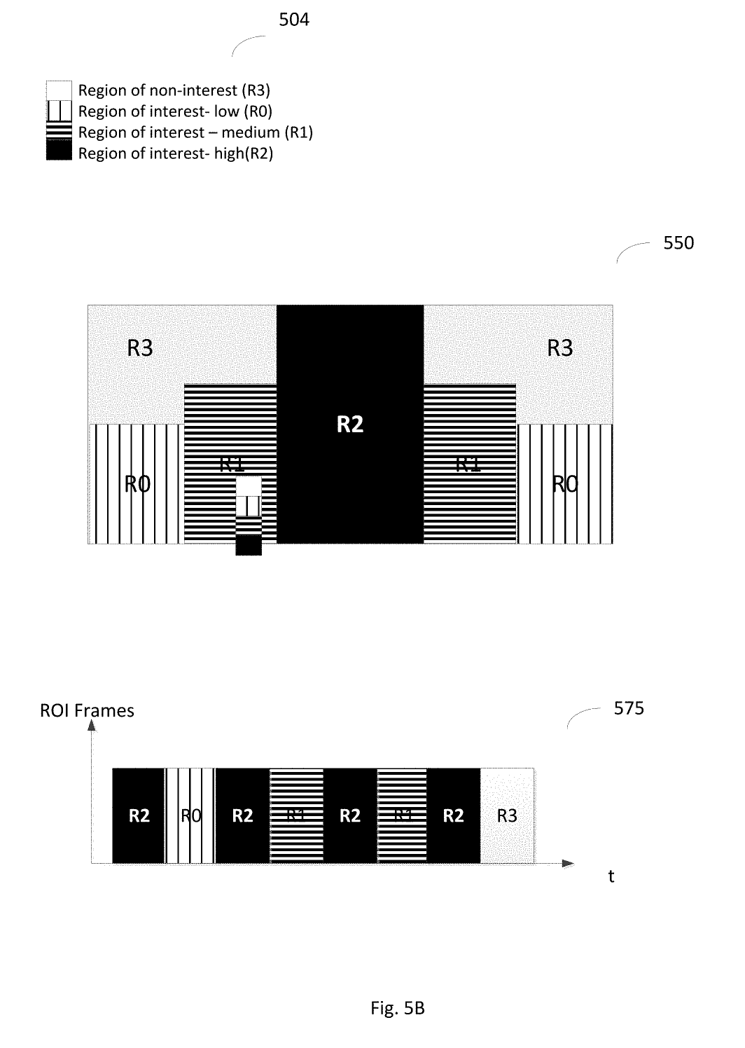

Turning to FIG. 5A, shown is a schematic of a scene 500 to be scanned by a scanning device traveling in the direction of arrow 502. The regions of interest of the scene are designated as either being a RONI or a ROI having a level of interest between low and high (see key 504). As is shown, the road delimiters and the buildings vertical planes, in the example, would be designated as being a region of high interest (R2), the pedestrian and a moving car a bit farther ahead are designated as regions of medium interest (R1) and the rest of the scene is generally considered a region of low interest (R0), the skyline is designated as a RONI (R3). As shown in FIG. 5B chart 550 the power or resource allocation for scene 500 is as determined by an associated controller which includes an SAL. Chart 575 depicts interleaving of ROIs in power allocation over time so that a signal intermittently allocates the most power to the region of highest interest R2, then to the region of medium interest R1 and lowest allocation to the low interest R0. Some power is also allocated to RONI R3 in order to periodically confirm that it is still a RONI.

Turning back to FIG. 2, SAL 226 may receive information from in-band and/or out-of-band sources. In-band sources are internal sources of scanning device 204 and may include vision signal 234, detected scene signal 210, PTX feedback 229, PSY feedback 230, and/or memory 222 and more. Analysis of these in-band sources may yield yet further in-band information. In band information may include a road plane and road delimiters, curbs, pedestrians, vehicles, a skyline, vertical planes such as building facets, tree canopies and more and intersections such as road intersections which may be considered a virtual plane. Additional in-band information may include laser power budget such as eye safety limitations, thermal limitation, reliability limitations and more which may be stored in memory 222. Additional in-band information may include electrical operational parameters such as peak currents and peak voltages, calibration data such as a detected and stored correction so that scanning device 204 is calibrated. Calibration data may be static, meaning tested and stored in an initiation or production process or may be dynamic to compensate for ongoing degradation or changes in the system such as operating temperature, operating voltage, etc. In-band information may also include an acquired background model, acquired ROI model and/or acquired RONI model each of which may be acquired overtime by scanning device 204, for example, if scanning device operates repeatedly in a certain location/area the system may accumulate scene information history via system learning models, ROI and RONI models and background models and store them locally.

According to some embodiments, out-of-band sources are external sources to scanning device 204. The out-of-band information may be received via host feedback 232. The out-of-band sources, however may be directly from host 228 or may be received by host 228 and relayed to scanning device 204. Out-of-band type information may include Inertial Measurement Unit (IMU), Ego-motion, brake or acceleration of the associated host, host wheel or wing position, GPS information, directional audio information (police siren, ambulance siren, car crash, people shouting, horns, tires screeching etc.), a background shared model and more. A background shared model may be a source of background local information such as a web map and more.

According to some embodiments, out-of-band sources which are sources in host 228 or associated with host 228 or detected by host 228 may include: a shared or pre-stored background model, accelerometer, gravity meter and additional sensors, an acquired background model, cameras and/or camera based features/element detection, landmark lists related to global or local positioning (such as GPS, Wireless, Wi-Fi, Bluetooth vehicle to vehicle infrastructure and more) which may be accessed via a crowd sharing model and may be downloaded from a shared storage such as a cloud server.

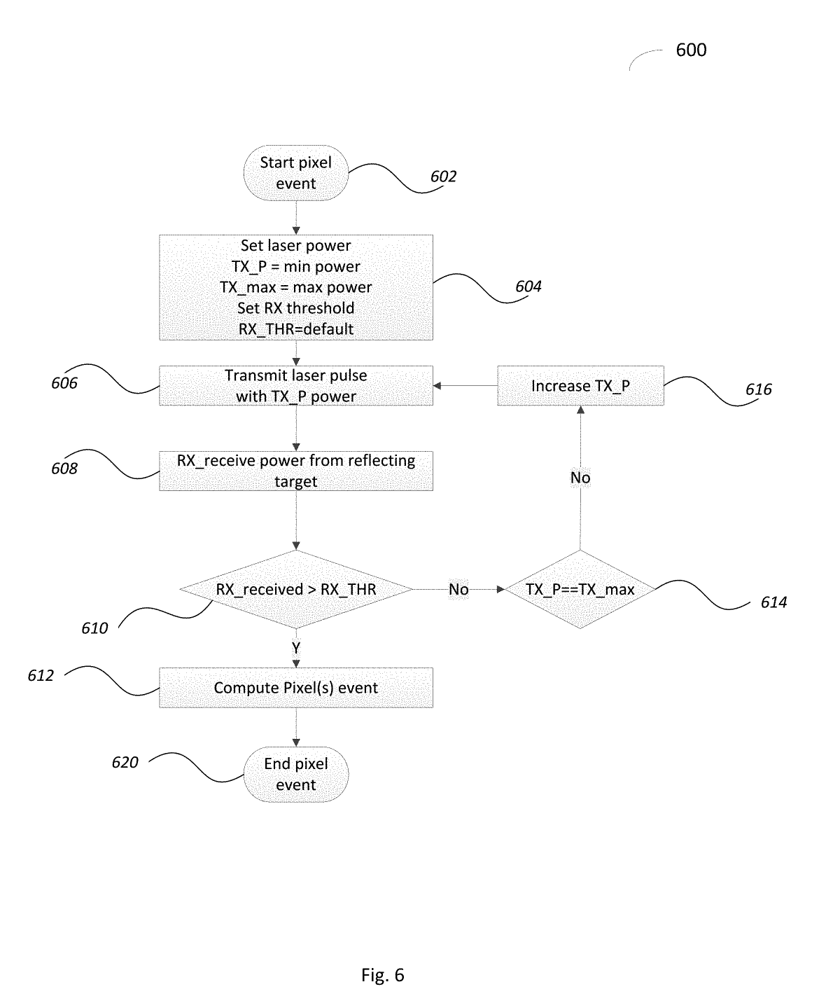

According to some embodiments, laser power may be controlled so that maximal signal power is not exceeded and maximal detection sensitivity is also not exceeded. With regard to maximal signal power not being exceeded, the power for a transmitted laser signal is distributed according to prioritization, taking into consideration an expected model as shown with regard to chart 575 for example. However, when considering return signals it is understood that a reflected signal is scene dependent, depending on the reflectivity of the scene elements, noise and ambient conditions as well as distance of elements a maximal threshold from a reflected signal may unintentionally be exceeded. To elaborate, if a series of signals are emitted and subsequently reflected signals are reflected back to the scanning device and ultimately to the detector then the reflected signal may exceed a maximal threshold since noise from external light sources may be added to the signal and a plurality of reflected signals may accumulate due to the differences in time till a return signal is returned based on the distance of the reflecting element. A method for avoiding exceeding a maximal reflected signal value by controlling the transmitted signal is shown in FIG. 6 in accordance with some embodiments. Flow chart 600 of FIG. 6 shows an initiation stage (602) initiating a scanning sequence in which the laser power is set to the minimal power setting (above zero) and the reflected signal is expected to be received at a default value (604). The signal is then transmitted with the predetermined signal power (606) which at this point is still the minimal power. Once a reflected signal is received the power is tested/checked (608) if the received signal has not reached its maximal power threshold (610) and if the transmitted signal has not reached its maximal power threshold (614) then the transmitted power level is increased (616). Once the maximal received signal threshold is received the scene may be detected and/or regular operation of the scanning device may proceed (620). It is understood that the monitoring of the received signal as described in flow chart 600 may be carried out in parallel to the regular operation of the scanning device and/or intermittently or periodically.

According to some embodiments, SAL 232 may also take into account accumulative temperature information and reduce QOS (by limiting, for example, the transmitted signal, detector power and more). Accordingly a work plan may be derived in accordance with an adjustable QOS. While peak current and/or voltage limitations may be more lenient since typically, even if a peak current/voltage event occurs it may immediately be relieved/stopped, with regard to exceeding a peak temperature the problem is harder to solve. Scanning device 204's temperature may be monitored in each block and/or in one or more dedicated sensors. It is understood that typically once a maximal threshold is exceeded it may be very difficult to cause scanning device 204 to cool down. Similarly, when extreme weather conditions occur (extreme heat and/or extreme cold for example) it may be preferable to reduce QOS but to maintain some level of detected scene output than having no output at all or causing scanning device 204 irreparable temperature harm. SAL 232 may be configured to prioritize temperature and weather conditions accordingly.

According to some embodiments, SAL 232 may prioritize information also based on if they are in-band or out-of-band information. For example, if a host signals to SAL 232 that a turn is expected that may cause work plan signal 234 to be updated regardless of scanning process since a new FOV is expected. Accordingly, an out-of-band signal/information may selectively interrupt a SAL 232 process for calculating/analyzing work plan signal 234. Optionally the host feedback may include an override command structure including a flag indicating that the host input is to override the internal feedbacks and signals. The override structure may contain direct designation to scan certain portion(s) of the scene at a certain power that translates into the LiDAR range and more.

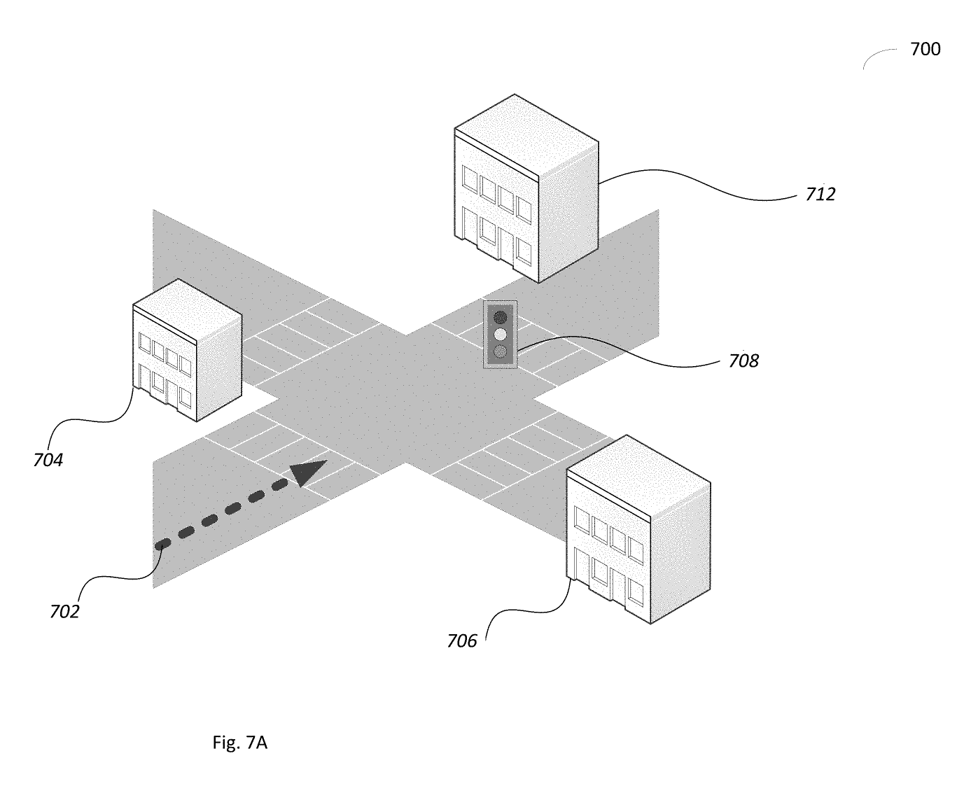

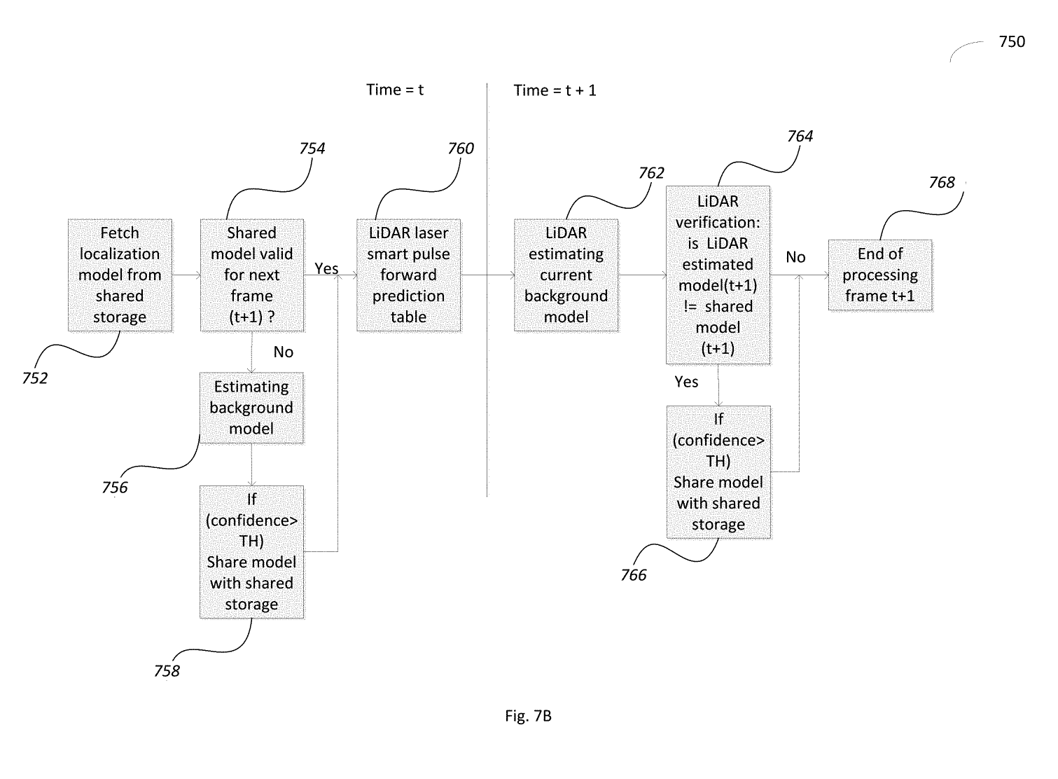

Turning to FIG. 7A shown is an example scene according to some embodiments, such as scene 700 which may include one or more background elements. Background elements may be regions of interest or regions of non-interest. A background model may be utilized so that SAL 226 may at least partially utilize a background model in order to analyze a scene based on a-priori information and produce a work plan signal 234. In example scene 700 a scanning device may be traveling in the direction as shown by arrow 702. Buildings 704 and 706 and traffic light 708 may be part of a background model stored in an associated memory or received from a host. An associated SAL may utilize this background information so that scanning device does not need to receive a signal to detect building 704 but rather only needs to confirm existence of the expected building. Accordingly, less resources need to be allocated to building 704 and it may be scanned periodically as a region of low interest. Similarly, traffic light 708 may also be part of a background model, and so does not need to be detected but rather confirmed. However, since it may be considered very important to a scanning device to detect the status (red, green etc.) and precise location of the traffic light based on the background model, the traffic light 708 may be designated as a region of high interest. A traffic light might also be a region of high interest for sensor information fusion, for example complementing an accurate position of a LiDAR with color information detection from a RGB camera.

According to some embodiments, elements of background such as building 712, may not be included in a background model and a scanning system may utilize system learning to update a background model.

Turning to FIG. 7B shown is a flow chart 750 in accordance with a system learning method for utilizing and updating a background model in accordance with some embodiments. While a frame is being detected at time t a localization or background model is retrieved from storage (752) the storage may be local or a shared remote storage or may be a local copy from a shared remote storage. The background model is verified, confirming that the background is relevant to the expected upcoming frame at t+1 (754). If the background model is inaccurate/irrelevant then a new background model may be estimated (756). For example, step 756 in the context of FIG. 7A may include verifying that buildings 704 and 706 exist. As discussed with regard to FIG. 7A building 712 did not exist in the background model, in which case the additional background information may be added to background model (758). The next step (based on the updated model or a correct model) is utilizing the background model for scanning frame at T+1 (762). If the model is confirmed by the captured scene elements as correct at t+1 it may be relayed to a shared background model (764 and 766) after which a scanning device may continue to a next frame (768) (such as T+2). Some redundancy or rechecking is described since a background model may require confirmation and validation before actually updating the model.

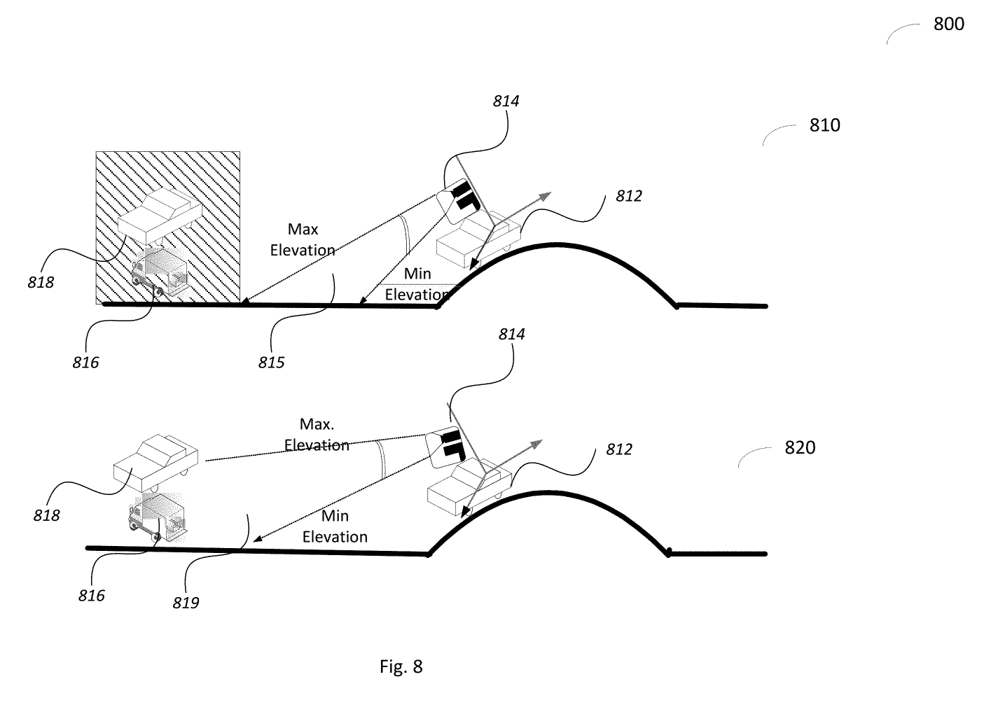

Turning to FIG. 8, shown are two identical scenes 810 and 820. Scene 810 includes a vehicle 812 with a scanning device 814. The vehicle is traveling downhill in the direction of a truck 816 and a second vehicle 818. The FOV of scanning device 814 is shown FOV 815 as having a minimal and maximal elevation point which neither truck 816 nor vehicle 818 fall within. Accordingly scanning device 814 cannot detect truck 816 or vehicle 818 and is only expected to do so when it gets substantially closer to them. Scene 820 is substantially similar however in scene 820 scanning device 814 has a dynamic FOV, and has updated FOV 819 with minimal and maximal FOV elevation based on the detected hill slope/incline vehicle 812 is driving on (acquired/detected/designated bay a work plan signal). Accordingly, both vehicle 818 and truck 816 are detected by scanning device 814 in scene 820. Accordingly, an SAL work plan may update a dynamic FOV. More examples are discussed in the following figures.

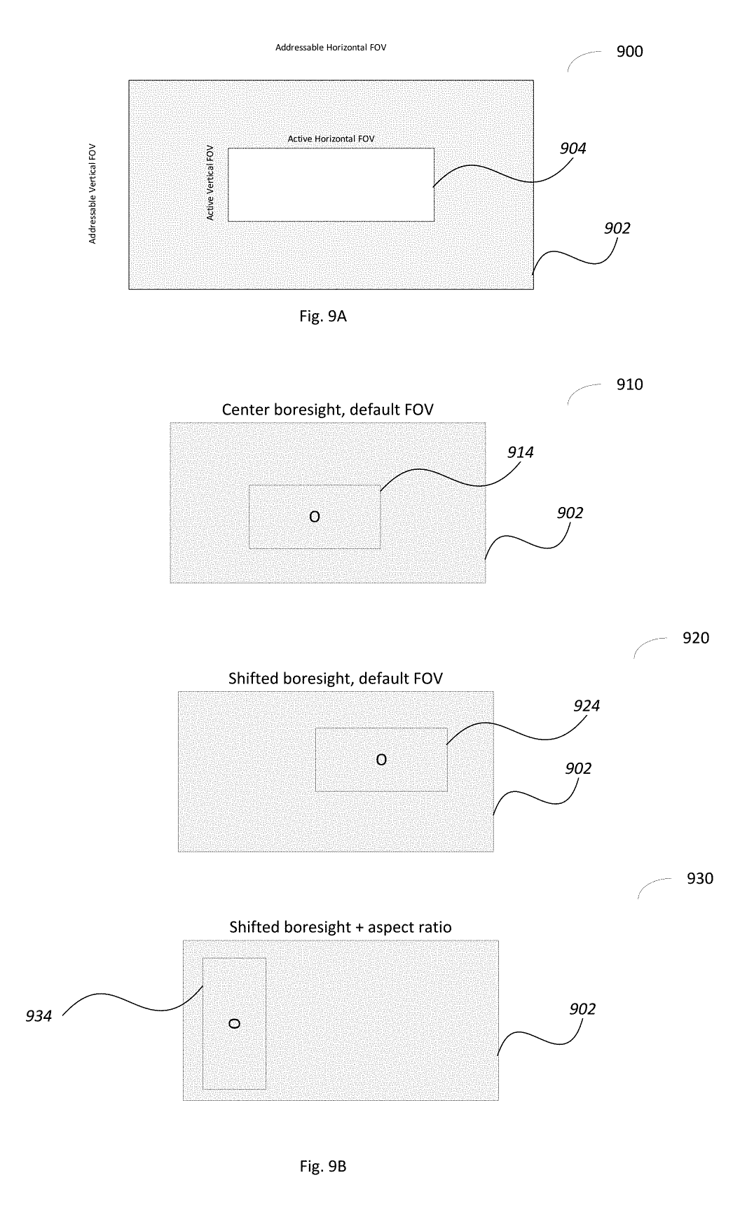

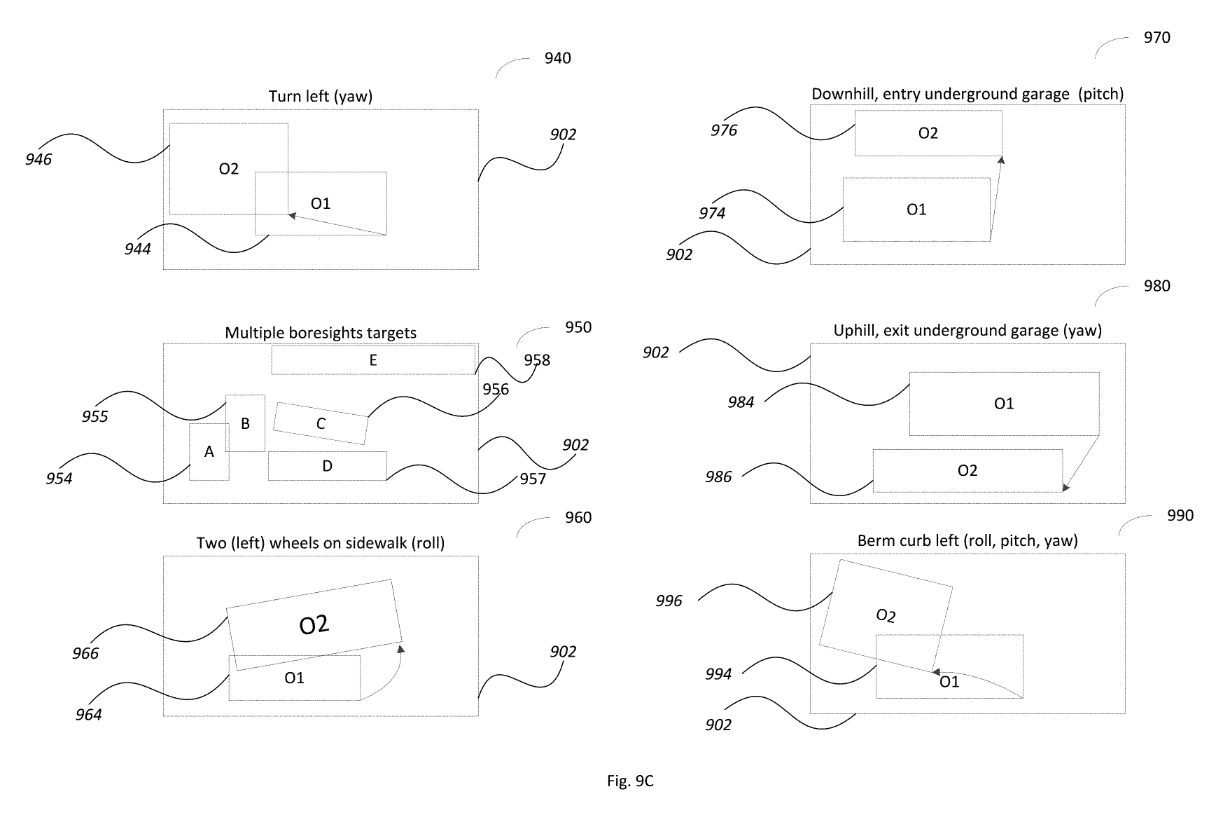

Turning to FIG. 9A shown is a FOV ratio 900 including maximal FOV 902 and an active FOV 904 within the maximal FOV 902, the active FOV selected by a SAL based on a work plan signal. FIG. 9B includes an example FOV 910 depicting a default FOV having a center boresight 914, an example FOV 920 having a default FOV with a shifted boresight 924 and an example FOV 930 having a shifted boresight and a shifted aspect ratio 934.

Turning to FIG. 9C shown are examples of FOV and a transition in the active FOV within maximal FOV 902. In this example yaw relates to movement in vertical axis, pitch relates to movement in lateral axis and roll to movement in longitudinal axis. FOV 940 shows a transition from a first active FOV 944 to a second active FOV 946 when a host intends to turn left. FOV 950 shows a plurality of active FOV (954-958) all acquired in parallel in accordance with a multiple boresight targets embodiment. FOV 960 shows a transition from a first active FOV 964 to a second active FOV 966 when a host having 4 wheels causes two left wheels to drive on the sidewalk causing movement in the roll axis. Rolling examples include: a bend is detected by LiDAR background estimation that causes the vehicle to roll sideways across the bend's berm. A host vehicle may drive/park partially on a sidewalk or other element that changes the vehicle's parallelism with respect to the road and the FOV. Furthermore, a static roll may be caused due to uneven weight distributed in the vehicle or a malfunction of the damping system.

According to some embodiments, FOV 970 shows a transition from a first active FOV 974 to a second active FOV 976 when a host is intending to or is moving downhill or into an underground garage causing movement in the pitch axis. Additional examples where a correction along the pitch axis may include situations where a vehicle is no longer parallel to the road and the vertical FOV is not optimal, speed bumpers which are a special case when both the altitude and the tilt angle of the LiDAR effective FOV changes, or a vehicle nose dive or elevation when vehicle brakes, accelerates or wind pressure at high speed causing the vehicle to change level position. Yet another example is a vehicle transitioning through short pathways that exhibit a large elevation difference, for example an underground parking: when exiting from an underground parking, the vehicle's front hood is obstructing the driver's FOV from perceiving obstacles at the end of the climb. Updating to active FOV enables overcoming these difficulties. Additional yaw correction examples include when a bend is detected by a background estimation and the active FOV is gradually shifted according to the speed and the bend features, in order to optimize the target FOV and ultimately detect obstacles in the bend's path. Another example, is when a change in wheel steering in a certain direction causes the FOV to shift towards that direction. Another example is when turn indicators (such as blinkers) provide a hint that the vehicle is expected to perform a turn in/to a specific direction. A special case is when the vehicle is stopped at an intersection, crossing road is detected as a background model and the turn indicator is active, the FOV would shift radically towards the turn direction in order to detect fast moving elements that may pose a threat

FOV 990 shows a transition from a first active FOV 994 to a second active FOV 996 when a host drives over a berm curb on the left causing a transition in roll pitch and yaw axis.

Turning back to FIG. 2, SAL 226 may determine work plan 234 which in turn may update any of scanning device 204 updateable parameters (discussed above) based on a plurality of situational parameters. Scene elements may be determined to be regions of interest by suppressing background features detected in a previous or current frame. Computer and vision processing may be utilized to detect scene elements and objects, such as computer and vision processing may include: motion tracking methods, geometrical correction, model matching (that a detected element is the same as an expected background element or meets a standard element which may be used to detect curbs, stoplights, signals and more). Furthermore, element and object prediction methods may be utilized based on current and previous frames.

According to some embodiments, SAL 226 may determine objects to be background or may confirm expected background objects are present in the scene. Background features may be predicted and as described above, accordingly they only need be verified and confirmed and therefore less power needs to be allocated in detecting these elements, allowing more power/resources to be allocated toward ROIs. SAL 226 may receive background models from a local memory, a shared storage and may also detect background elements independently. Furthermore, SAL 226 may update work plan 234 based on location and/or trajectory of a host platform 228, detected topography, and more. Furthermore, FOV determined by SAL 220 may cause an update in work plan 234 may update a dynamic FOV so that the required/appropriate FOV is scanned.

According to some embodiments, work plan 234 may be produced based on (a) real-time detected scene signal (b) intra-frame level scene signal and (c) inter-frame level scene signal accumulated and analyzed over two or more frames. According to some embodiments, work plan 234 may be updated based on real time detected scene information which may also be termed as pixel information. Real time information may analyze detected fast signals during time of flight that contains one or more reflections for a given photonic inspection pulse. For example, an unexpected detected target in a low priority field may cause controller 218 to update the pulse frequency of the laser of PTX 206 via updating of the pulse parameters. Work plan 234 may also be updated at a frame or sub-frame level which may be information received accumulated and/or analyzed within a single frame. Furthermore, work plan 234 may be updated on an inter-frame level, which is information accumulated and analyzed over two or more frames. Increased levels of real time accuracy, meaning that work plan 234 is updated in a pixel or sub-frame resolution, is carried out when higher levels of computation produce increasingly usable results. Increased level of non-real time accuracy within a specific time period as slower converging data becomes available (e.g. computer vision generated optical flow estimation of objects over several frames), meaning that work plan 234 may be updated as new information becomes evident based on an inter-frame analysis.

According to some embodiments, Host 228 may include steering modules, GPS, crowd sharing background source, and additional scanning devices, cameras and more.

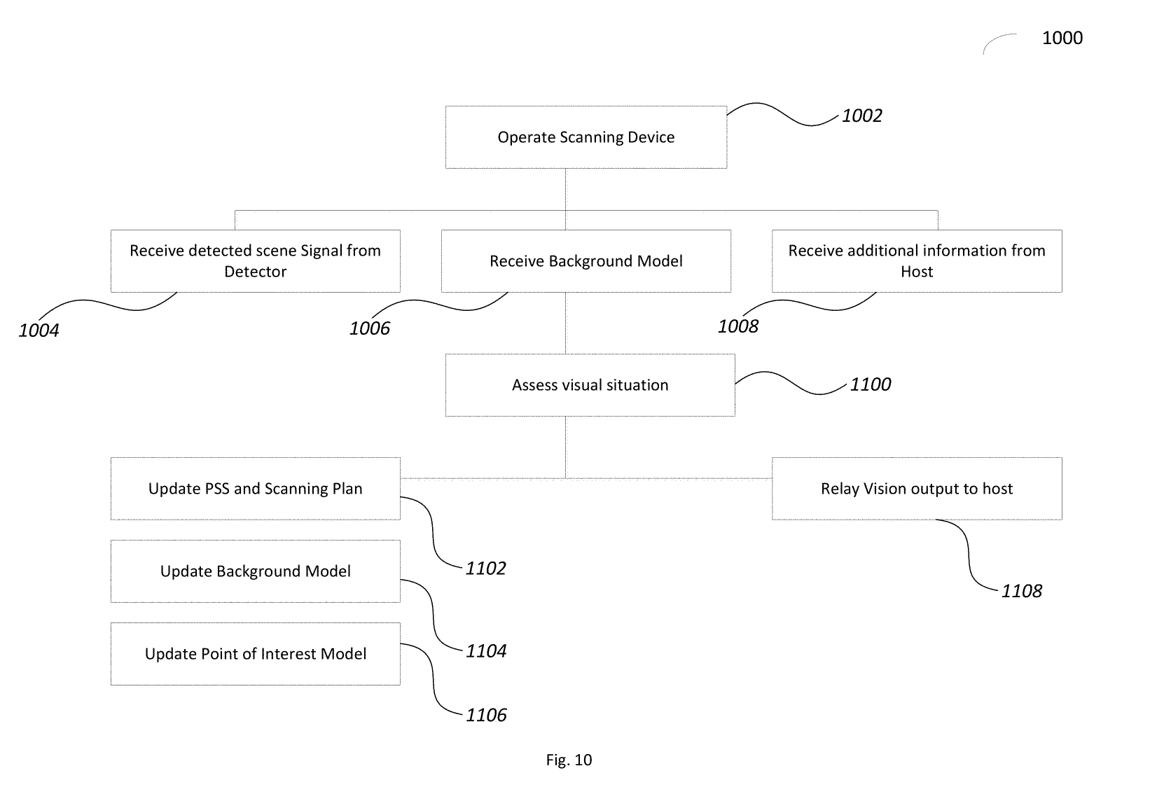

Turning to FIG. 10 shown is a flow chart 1000 for scanning a scene in accordance with some embodiments. A scanning device may be operated (1002) to scan a scene. A scene signal may be received alongside internal control signals of the scanning device (1004) as well as a background model (1006) and signal from an associated host (1008). The scanning device may assess a visual situation based on at least one of the these signals (1100) and may update a scanning plan (1102), a background model (1104), and/or a RONI model (1106) as well as outputting a vision output to a host device (1108), the scanning plan may cause an update in the PTX, PRX and/or PSY including updating pulses parameters, scanning parameters and/or detecting parameter and a change in the dynamic FOV.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A scanning device comprising:
a photonic emitter assembly (PTX) to emit at least one pulse of inspection photons in accordance with at least one adjustable pulse parameter;
a photonic reception and detection assembly (PRX) to receive reflected photons reflected back from an object, said PRX including a detector to detect in accordance with at least one adjustable detection parameter the reflected photons and produce a detected scene signal;
a photonic steering assembly (PSY) functionally associated with both said PTX and said PRX to direct said pulses of inspection photons in a direction of an inspected scene segment and to steer said reflection photons back to said PRX; and
a closed loop controller to: (a) control said PTX, PRX and PSY, (b) receive said detected scene signal from said detector and (c) update said at least one pulse parameter and at least one detection parameter at least partially based on a work plan indicative of an estimated composition of scene elements present within the scene segment covered by the given set of inspection pulses, said work plan derived at least partially from said detected scene signal.

2. The device according to claim 1, wherein said steering assembly is configured to direct and to steer in accordance with at least one adjustable steering parameter, determined by said work plan.

3. The device according to claim 2, wherein said steering parameters are selected from the group consisting of: transmission pattern, sample size of the scene, power modulation that defines the range accuracy of the scene, correction of axis impairments and field of view determination, scanning method, single or multiple deflection axis methods, and synchronization components.

4. The device according to claim 1, wherein said pulse parameter is selected from the group consisting of: pulse power intensity, pulse width, pulse repetition rate, pulse sequence, pulse duty cycle, wavelength, phase and polarization.

5. The device according to claim 4, wherein said detection parameter is selected from the group consisting of: scanning direction, frame rate, ambient light effects, mechanical static and dynamic impairments and thermal effects.

6. The device according to claim 1, wherein said work plan is further derived from a background model.

7. The device according to claim 6, wherein said work plan is further derived from a region of interest model.

8. The device according to claim 7, wherein said work plan is further derived from a region of non-interest model.

9. The device according to claim 7, wherein said work plan is further derived from a host signal.

10. The device according to claim 3, wherein said steering parameter is a field of view determination and said work plan is derived at least partially from a host signal.

11. The device according to claim 3, wherein said detected scene signal is emitted in accordance with an adjustable quality of service.

12. An autonomous vehicle comprising:
a scanning device including: (a) a photonic emitter assembly (PTX) to emit at least one pulse of inspection photons in accordance with at least one adjustable pulse parameter; (b) a photonic reception and detection assembly (PRX) to receive reflected photons reflected back from an object, said PRX including a detector to detect in accordance with at least one adjustable detection parameter the reflected photons and produce a detected scene signal; and (c) a closed loop controller to: (i) control said PTX and PRX, (ii) receive said detected scene signal from said detector and (iii) update said at least one pulse parameter and at least one detection parameter at least partially based on a work plan indicative of an estimated composition of scene elements present within the scene segment covered by the given set of inspection pulses, said work plan derived at least partially from said detected scene signal; and
a host controller to receive said detected scene signal and to relay a host feedback to said scanning device including host ego-motion information.

13. The autonomous vehicle of claim 12, wherein said ego-motion information is selected from the list consisting of: wheels steering position, vehicle speed, vehicle acceleration, vehicle braking, headlights status, turning lights status and GPS location information.

14. The autonomous vehicle of claim 12, wherein said pulse parameter is selected from the group consisting of: pulse power intensity, pulse width, pulse repetition rate, pulse sequence, pulse duty cycle, wavelength, phase and polarization.

15. The autonomous vehicle of claim 12, wherein said detection parameter is selected from the group consisting of: scanning direction, frame rate, ambient light effects, mechanical static and dynamic impairments and thermal effects.

16. The autonomous vehicle of claim 12, wherein said work plan is further derived from a background model at least partially stored in said host controller and relayed to said scanning device via said host feedback.

17. The autonomous vehicle of claim 12, wherein said detected scene signal is emitted in accordance with an adjustable quality of service.

18. A method of scanning a scene comprising:
emitting at least one pulse of inspection photons in accordance with at least one adjustable pulse parameter;
detecting in accordance with at least one adjustable detection parameter reflected photons and producing a detected scene signal;
estimating a scene composition of scene elements present within a scene segment and deriving a scanning plan at least partially from said detected scene signal; and
updating at least one pulse parameter and at least one detection parameter at least partially based on said scanning plan.
